(19) United States
(12) Patent Application Publication
(10) Pub. No.: US 2024/0347896 A1
(43) Pub. Date: Oct. 17, 2024

(54) WEARABLE DEVICE

(71) Applicant: HUAWEI TECHNOLOGIES CO., LTD., Shenzhen, Guangdong (CN)

(72) Inventors: Yanyi LU, Shenzhen (CN); Bo MENG, Dongguan (CN); Yi FAN, Dongguan (CN); Baokun XI, Shanghai (CN)

(21) Appl. No.: 18/574,574

(22) PCT Filed: Jun. 2, 2022
(86) PCT No.: PCT/CN2022/096763

§ 371 Date: Dec. 27, 2023

(30) Foreign Application Priority Data
Jun. 30, 2021 (CN) 202110745113.4

(51) Int. Cl. H01Q 1/27; H01Q 1/50; H01Q 23/00; H01Q 25/00; H04R 1/10

(52) U.S. Cl. CPC H01Q 1/273; H01Q 1/50; H01Q 23/00; H01Q 25/00; H04R 1/1016; H04R 1/1041; H04R 2420/07

(57) ABSTRACT

Implementations in the application provide wearable devices. In an implementation, a wearable device includes a housing, a printed circuit board (PCB), a feeding unit, and a switch. The housing includes a metal portion configured as an antenna radiator. The PCB is disposed in the housing and disposed opposite to the metal portion. The feeding unit is electrically connected to a first end of the metal portion and feeds the antenna radiator. One end of the switch is electrically connected to a second end of the metal portion, and the other end of the switch is grounded. The switch has a first switch state or a second switch state, and an operating frequency band of the antenna radiator includes a first frequency band.

This application claims priority to Chinese Patent Application No. 202110745113.4, filed with the China National Intellectual Property Administration on Jun. 30, 2021, and entitled “WEARABLE DEVICE”, which is incorporated herein by reference in its entirety.

### TECHNICAL FIELD

This application relates to the field of wireless communication, and in particular, to a wearable device.

### BACKGROUND

Wireless headsets, especially true wireless stereo (TWS) Bluetooth (BT) headsets, are portable and miniature, and therefore are increasingly loved by a user. However, because the TWS headsets are directly worn on the user's ears, antenna performance of the TWS headsets is easily affected by the user's head, and consequently it is difficult to implement excellent antenna performance. Similarly, other wearable devices worn by the user, such as a smart watch and smart glasses, have an identical problem.

### SUMMARY

This application provides a wearable device. A metal portion of a housing of the wearable device is configured as an antenna radiator, and different operating modes of the antenna radiator in an identical operating frequency band are implemented through switching of a switch.

According to a first aspect, a wearable device is provided, and includes: a housing, including a metal portion, where the metal portion is configured as an antenna radiator; a printed circuit board PCB, disposed within the housing, where the PCB is disposed opposite to the metal portion of the housing: a feeding unit, electrically connected to a first end of the metal portion and feeding the antenna radiator; and a first switch, where one end of the first switch is electrically connected to a second end of the metal portion, and the other end of the first switch is grounded. When the first switch switches to a first switch state or a second switch state, an operating frequency band of the wearable device includes a first frequency band.

According to the technical solution of embodiments of this application, the first switch switches between electrical connection states between the second end of the metal portion and a floor, so that different operating modes of the antenna radiator in the first frequency band can be implemented. It may be considered that the antenna radiator in different operating modes corresponds to different antenna elements, for example, including a first antenna element and a second antenna element. The first antenna element and the second antenna element share a radiator. When the first switch is closed, the second end of the metal portion is grounded, to form the first antenna element. When the feeding unit performs feeding, an electromagnetic field generated by the first antenna element is similar to that generated by differential feeding. When the first switch is open, the second end of the metal portion is not connected to the floor, to form the second antenna element. When the feeding unit performs feeding, an electromagnetic field generated by the second antenna element is similar to that generated by in-phase feeding. Therefore, a state of the first switch is controlled to switch between the first antenna element and the second antenna element. Because the differential feeding and the in-phase feeding use an identical radiator to generate radiation, patterns of the first antenna element and the second antenna element are complementary, and the patterns may be switched by switching between the two antenna elements when a packet loss ratio is lower than a threshold. Therefore, coverage of a pattern of an antenna structure 201 is increased (where for example. 360° omnidirectional coverage is implemented), so as to implement a stable connection and improve user experience. In addition, the metal portion of the housing is configured as the antenna radiator, so that it can be ensured that an antenna in the wearable device obtains a large headroom (away from the PCB/the floor/a battery/a component) and generates good radiation performance.

With reference to the first aspect, in some implementations of the first aspect, a distance between a connection of the feeding unit and the metal portion and a connection of the end of the first switch and the metal portion is greater than or equal to one-eighth of a first wavelength, and the first wavelength is a wavelength corresponding to the first frequency band.

With reference to the first aspect, in some implementations of the first aspect, when the first switch is in the first switch state, the second end of the metal portion is grounded through the first switch; and

when the first switch is in the second switch state, the second end of the metal portion is not grounded through the first switch.

According to the technical solution of embodiments of this application, the state of the first switch is controlled, so that the operating mode of the antenna can be controlled to switch between the first antenna element and the second antenna element.

With reference to the first aspect, in some implementations of the first aspect, the first switch is a single-pole single-throw switch, a single-pole double-throw switch, a single-pole four-throw switch, or a four-pole single-throw switch.

According to the technical solution of embodiments of this application, the switch may be a single-pole single-throw switch, or other types of switches, for example, a single-pole double-throw switch, a single-pole four-throw switch, or a four-pole single-throw switch, and an identical technical effect can still be achieved.

With reference to the first aspect, in some implementations of the first aspect, the first switch may alternatively be a component of another type. The first switch may be an adjustable capacitor, and a capacitance value of the adjustable capacitor changes to switch between electrical connection states between a metal layer 221 and the metal portion 211. The adjustable capacitor includes a first capacitance state and a second capacitance state, respectively corresponding to the first switch state and the second switch state of the first switch. The first capacitance state corresponds to a first capacitance value, the second capacitance state corresponds to a second capacitance value, and setting of the first capacitance value and the second capacitance value is related to operating frequency of the antenna radiator.

With reference to the first aspect, in some implementations of the first aspect, a first capacitance value corresponding to a first capacitance state is less than or equal to 0.2 pF, and a second capacitance value corresponding to a second capacitance state is greater than or equal to 10 pF.

According to the technical solution of embodiments of this application, for a Bluetooth frequency band (for example. 2.4 to 2.485 GHZ), when a capacitance value of the adjustable capacitor is 0.2 pF, it can be considered that the second end of the metal portion is not connected to a metal layer; and when the capacitance value of the adjustable capacitor is 10 pF, it can be considered that the second end of the metal portion is electrically connected to the metal layer.

With reference to the first aspect, in some implementations of the first aspect, the PCB includes a metal layer, the metal layer is disposed opposite to the metal portion of the housing, and the other end of the first switch is electrically connected to the metal layer and grounded through the metal layer. One end of the feeding unit is electrically connected to the first end of the metal portion, and the other end of the feeding unit is electrically connected to the metal layer.

According to the technical solution of embodiments of this application, the metal layer in the PCB may be used as a ground plane/floor in the wearable device, or may be electrically connected to the floor and equivalent to the floor.

With reference to the first aspect, in some implementations of the first aspect, the feeding unit and/or the first switch are/is disposed on the PCB.

According to the technical solution of embodiments of this application, the feeding unit and the first switch may be disposed on an identical substrate (such as the PCB), or may alternatively be disposed on two or more different substrates based on a layout requirement, for example, disposed on different PCBs and/or flexible printed circuits (FPCs). This is not limited in this application, and may be adjusted based on an actual design.

With reference to the first aspect, in some implementations of the first aspect, the wearable device includes a matching network: the first end of the metal portion includes a first feeding point and a second feeding point: the matching network includes a first radio frequency circuit, a second radio frequency circuit, and a second switch: one end of the first radio frequency circuit is electrically connected to the metal portion at the first feeding point, and the other end of the first radio frequency circuit is electrically connected to the second switch: one end of the second radio frequency circuit is electrically connected to the metal portion at the second feeding point, and the other end of the second radio frequency circuit is electrically connected to the second switch; and the second switch is electrically connected to the feeding unit.

With reference to the first aspect, in some implementations of the first aspect, the matching network further includes a third radio frequency circuit; and one end of the third radio frequency circuit is disposed between the second switch and the feeding unit, and the other end of the third radio frequency circuit is grounded.

According to the technical solution of embodiments of this application, the first switch is used to switch between two states (not grounded and grounded) of the second end of the metal portion, and the second switch may be used to switch matching of the first antenna element and the second antenna element, for example, through frequency tuning. In order to prevent reactances of matching networks from affecting each other during switching, reactances (a reactance of the first radio frequency circuit and a reactance of the second radio frequency circuit) that are connected in series and that correspond to the two antenna elements may be switched via the second switch. In addition, a reactance (a reactance of the third radio frequency circuit) that is connected in parallel may be placed between the second switch and the feeding unit rather than between the feeding point and the second switch, which not only ensures a switching effect of the second switch on the matching networks, but also prevents the reactances, of different matching networks corresponding to the first antenna element and the second antenna element, from affecting each other, and can reduce a layout of electronic components.

With reference to the first aspect, in some implementations of the first aspect, the first radio frequency circuit includes a first capacitor: the second radio frequency circuit includes a first inductor; and the third radio frequency circuit includes a second inductor.

According to the technical solution of embodiments of this application, the first capacitor and the second inductor may be used to match the first antenna element, to optimize radiation characteristics of the first antenna element. The first inductor and the second inductor may be used to match the second antenna element, to optimize radiation characteristics of the second antenna element.

With reference to the first aspect, in some implementations of the first aspect, a capacitance value of the first capacitor is between 0.5 pF and 1.5 pF, an inductance value of the first inductor is between 1 nH and 2 nH, and an inductance value of the second inductor is between 1 nH and 2 nH.

With reference to the first aspect, in some implementations of the first aspect, a capacitance value of the first capacitor is 1 pF, an inductance value of the first inductor is 1.5 nH, and an inductance value of the second inductor is 1.5 nH.

According to the technical solution of embodiments of this application, in an actual production design, specific data of the first capacitor, the first inductor, and the second inductor may be adjusted in different electromagnetic environments. The foregoing values are only used as examples in this application, and are not limited thereto.

With reference to the first aspect, in some implementations of the first aspect, the first frequency band is a Bluetooth frequency band. The wearable device may support a Bluetooth frequency band through the antenna radiator. No matter when the first switch is in the first switch state or the second switch state, the wearable device may support the Bluetooth frequency band through the antenna radiator.

According to the technical solution of embodiments of this application, a frequency band supported by the wearable device through the antenna radiator may alternatively correspond to a frequency band of a global positioning system (GPS) communication technology, a wireless fidelity (Wi-Fi) communication technology: a global system for mobile communications (GSM) communication technology, a wideband code division multiple access (WCDMA) communication technology, a long term evolution (LTE) communication technology, a 5th generation (5G) communication technology, or other future communication technologies.

With reference to the first aspect, in some implementations of the first aspect, the wearable device is true wireless TWS headsets, a smart watch, or smart glasses.

The technical solution of embodiments of this application may be applied to other wearable devices, and this is not limited in this application.

According to a second aspect, an antenna is provided and includes: a radiator, a printed circuit board PCB, a feeding unit, and a first switch, where the radiator is disposed opposite to the PCB: the feeding unit is electrically connected to a first end of the radiator and feeds the radiator: one end of the first switch is electrically connected to a second end of the radiator, and the other end of the first switch is grounded. When the first switch is switched to a first switch state or a second switch state, an operating frequency band of the antenna includes a first frequency band. The radiator can be a metal radiator.

According to the technical solution of embodiments of this application, the first switch switches electrical connection states between the second end of the radiator and a floor, so that different operating modes of the radiator in the first frequency band can be implemented. It may be considered that the radiator in different operating modes corresponds to different antenna elements, for example, including a first antenna element and a second antenna element. The first antenna element and the second antenna element share a radiator. When the first switch is closed, the second end of the radiator is grounded, to form the first antenna element. When the feeding unit performs feeding, an electromagnetic field generated by the first antenna element is similar to that generated by differential feeding. When the first switch is open, the second end of the radiator is not connected to the floor, to form the second antenna element. When the feeding unit performs feeding, an electromagnetic field generated by the second antenna element is similar to that generated by in-phase feeding. Therefore, a state of the first switch is controlled to switch between the first antenna element and the second antenna element. Because differential feeding and in-phase feeding use an identical radiator to generate radiation, patterns of the first antenna element and the second antenna element are complementary, and the patterns may be switched by switching between the two antenna elements when a packet loss ratio is lower than a threshold. Therefore, coverage of a pattern of the antenna is increased (where for example, 360° omnidirectional coverage is implemented), so as to implement a stable connection and improve user experience. The antenna may be used in a wearable device. The radiator may be formed by using a metal housing portion of the wearable device, so as to ensure that an antenna radiator of the wearable device obtains a large headroom (away from the PCB/the floor/a battery/a component) and generates good radiation performance.

With reference to the second aspect, in some implementations of the second aspect, a distance between a connection of the feeding unit and the metal radiator and a connection of the end of the first switch and the metal radiator is greater than or equal to one-eighth of a first wavelength, and the first wavelength is a wavelength corresponding to the first frequency band.

With reference to the second aspect, in some implementations of the second aspect, when the first switch is in the first switch state, the second end of the metal radiator is grounded through the first switch; and when the first switch is in the second switch state, the second end of the metal radiator is not grounded through the first switch.

With reference to the second aspect, in some implementations of the second aspect, the first switch is a single-pole single-throw switch, a single-pole double-throw switch, a single-pole four-throw switch, or a four-pole single-throw switch.

With reference to the second aspect, in some implementations of the second aspect, the first switch is an adjustable capacitor. The adjustable capacitor includes a first capacitance state and a second capacitance state, respectively corresponding to the first switch state and the second switch state of the first switch. The first capacitance state corresponds to a first capacitance value, the second capacitance state corresponds to a second capacitance value, and setting of the first capacitance value and the second capacitance value is related to operating frequency of the antenna.

With reference to the second aspect, in some implementations of the second aspect, a first capacitance value corresponding to a first capacitance state is less than or equal to 0.2 pF, and a second capacitance value corresponding to a second capacitance state is greater than or equal to 10 pF.

With reference to the second aspect, in some implementations of the second aspect, the PCB includes a metal layer, the metal layer is disposed opposite to the metal radiator, and the other end of the first switch is electrically connected to the metal layer and grounded through the metal layer. One end of the feeding unit is electrically connected to the first end of the metal radiator, and the other end of the feeding unit is electrically connected to the metal layer.

With reference to the second aspect, in some implementations of the second aspect, the feeding unit and/or the first switch are/is disposed on the PCB. With reference to the second aspect, in some implementations of the second aspect, the wearable device includes a matching network: the first end of the metal portion includes a first feeding point and a second feeding point: the matching network includes a first radio frequency circuit, a second radio frequency circuit, and a second switch: one end of the first radio frequency circuit is electrically connected to the metal portion at the first feeding point, and the other end of the first radio frequency circuit is electrically connected to the second switch: one end of the second radio frequency circuit is electrically connected to the metal portion at the second feeding point, and the other end of the second radio frequency circuit is electrically connected to the second switch; and the second switch is electrically connected to the feeding unit.

With reference to the second aspect, in some implementations of the second aspect, the matching network further includes a third radio frequency circuit; and one end of the third radio frequency circuit is disposed between the second switch and the feeding unit, and the other end of the third radio frequency circuit is grounded.

With reference to the second aspect, in some implementations of the second aspect, the first radio frequency circuit includes a first capacitor: the second radio frequency circuit includes a first inductor; and the third radio frequency circuit includes a second inductor.

With reference to the second aspect, in some implementations of the second aspect, a capacitance value of the first capacitor is between 0.5 pF and 1.5 pF, an inductance value of the first inductor is between 1 nH and 2 nH, and an inductance value of the second inductor is between 1 nH and 2 nH.

With reference to the second aspect, in some implementations of the second aspect, a capacitance value of the first capacitor is 1 pF, an inductance value of the first inductor is 1.5 nH, and an inductance value of the second inductor is 1.5 nH.

According to the technical solution of embodiments of this application, the feeding unit and the first switch may be disposed on an identical substrate, or disposed on two or more different substrates. The matching network and the feeding unit and/or the first switch may be disposed on an identical substrate, or disposed on two or more different substrates. Different substrates may include a PCB, and/or an FPC. This is not limited in this application, and may be adjusted based on an actual design.

With reference to the second aspect, in some implementations of the second aspect, the first frequency band is a Bluetooth frequency band. The antenna may be used in the wearable device, and the wearable device supports the Bluetooth frequency band through the antenna. No matter when the first switch is in the first switch state or the second switch state, the wearable device may support the Bluetooth frequency band through the antenna. The wearable device is true wireless TWS headsets, a smart watch, or smart glasses.

The first frequency band may alternatively correspond to a frequency band of a global positioning system (GPS) communication technology, a wireless fidelity (Wi-Fi) communication technology, a global system for mobile communications (GSM) communication technology, a wideband code division multiple access (WCDMA) communication technology, a long term evolution (LTE) communication technology, a 5th generation (5G) communication technology, or other future communication technologies.

### BRIEF DESCRIPTION OF DRAWINGS

FIG. 1(a), FIG. 1(b), and FIG. 1(c) are a schematic diagram of a structure of a wearable device according to an embodiment of this application;

FIG. 2 is a schematic diagram of comparison between patterns of an antenna structure of a TWS headset in different cases:

FIG. 3 is a schematic diagram of switching between patterns of an antenna structure according to an embodiment of this application:

FIG. 4 is a schematic diagram of an equivalence principle of anisotropic charges according to this application:

FIG. 5 is a schematic diagram of an equivalence principle of isotropic charges according to this application:

FIG. 6 is a schematic diagram of an equivalence principle of reverse current sources according to this application:

FIG. 7 is a schematic diagram of an equivalence principle of codirectional current sources according to this application:

FIG. 8 is a schematic diagram of an antenna structure according to this application:

FIG. 9 is a schematic diagram of a principle of differential feeding according to this application:

FIG. 10 is a schematic diagram of a principle of in-phase feeding according to this application:

FIG. 11 is a schematic diagram in which an equivalence principle of reverse current sources is used:

FIG. 12 is a schematic diagram in which an equivalence principle of codirectional current sources is used:

FIG. 13 is a simulated schematic diagram of differential feeding:

FIG. 14 is a simulated schematic diagram of in-phase feeding:

FIG. 15 is a schematic diagram of a structure of a wearable device 200 according to an embodiment of this application:

FIG. 16 is a schematic diagram of an antenna structure 201 according to an embodiment of this application:

FIG. 17 is a schematic diagram of a structure of a metal spring according to an embodiment of this application:

FIG. 18 is a schematic diagram of electric field distribution generated when in-phase feeding is performed on a control group according to this application:

FIG. 19 is a pattern generated when in-phase feeding is performed on a control group according to this application:

FIG. 20 is a schematic diagram of electric field distribution generated when a switch in the antenna structure shown in FIG. 16 is in a second switch state according to this application:

FIG. 21 is a pattern generated when a switch in the antenna structure shown in FIG. 16 is in a second switch state according to this application:

FIG. 22 is a schematic diagram of electric field distribution generated when differential feeding is performed on a control group according to this application:

FIG. 23 is a pattern generated when differential feeding is performed on a control group according to this application:

FIG. 24 is a schematic diagram of electric field distribution generated when a switch in the antenna structure shown in FIG. 16 is in a first switch state according to this application:

FIG. 25 is a pattern generated when a switch in the antenna structure shown in FIG. 16 is in a first switch state according to this application:

FIG. 26 is a schematic diagram of an antenna structure 300 according to an embodiment of this application:

FIG. 27 is a Smith chart of a first antenna element and a second antenna element according to an embodiment of this application:

FIG. 28 is a diagram of S-parameter simulation results of the antenna structure shown in FIG. 26:

FIG. 29 is a diagram of simulation results of system efficiency (total efficiency) of the antenna structure shown in FIG. 26;

FIG. 30 is a schematic diagram of coordinates in a polarization manner according to an embodiment of this application:

FIG. 31(a), FIG. 31(b), and FIG. 31(c) are patterns, on a horizontal surface of a head model, of the antenna structure shown in FIG. 26;

FIG. 32(a), FIG. 32(b), and FIG. 32(c) are patterns, on a lateral surface of a head model, of the antenna structure shown in FIG. 26:

FIG. 33(a), FIG. 33(b), and FIG. 33(c) are patterns, on a front surface of a head model, of the antenna structure shown in FIG. 26:

FIG. 34 shows another wearable device according to an embodiment of this application; and

FIG. 35 shows another wearable device according to an embodiment of this application.

### DESCRIPTION OF EMBODIMENTS

The technical solution in this application is described below with reference to the accompanying drawings.

It should be understood that, in this application, an “electrical connection” may be understood as a physical contact and electrical conduction of components, or may be understood as a form of connection between different components in a circuit structure through a printed circuit board (PCB), a copper foil, or a physical line such as a wire on which transmission of an electrical signal can be performed, or may be understood as electrical conduction between components through indirect coupling without a physical contact. A “communication connection” may refer to electrical signal transmission, and includes a wireless communication connection and a wired communication connection. The wireless communication connection does not require a physical medium and does not belong to a connection relationship that limits construction of a product. “Connection” and “connected” may both refer to a mechanical connection relationship or a physical connection relationship. For example, that A and B are in connection or that A and B are connected may mean: There is a fastening member (such as a screw; a bolt, or a rivet) between A and B, or A and B are in contact with each other and it is difficult for A and B to separate from each other.

The technical solution provided in this application is applicable to wearable devices using one or more of the following communication technologies: a BT communication technology, a global positioning system (GPS) communication technology, a wireless fidelity (Wi-Fi) communication technology, a global system for mobile communications (GSM) communication technology: a wideband code division multiple access (WCDMA) communication technology, a long term evolution (LTE) communication technology, a 5th generation (5G) communication technology, or other future communication technologies.

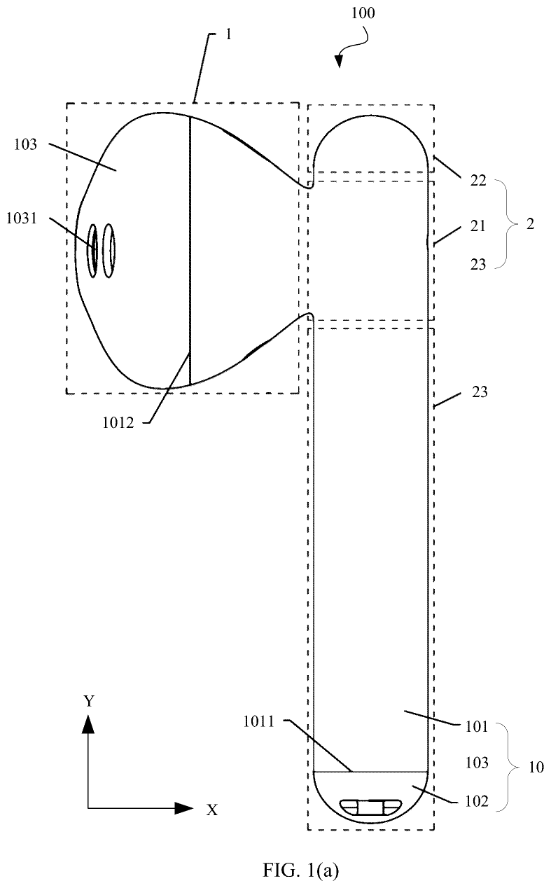

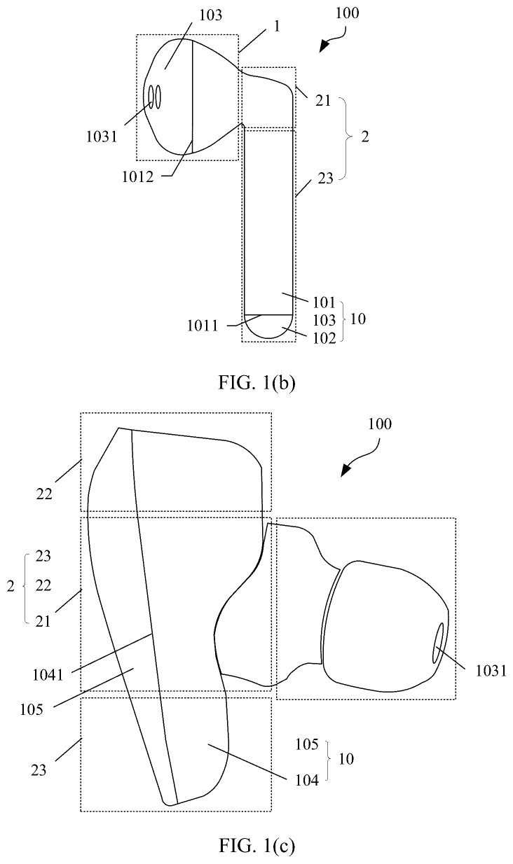

FIG. 1(a). FIG. 1(b), and FIG. 1(c) are a schematic diagram of a structure of a wearable device according to an embodiment of this application. An example of a wireless headset is used for description.

FIG. 1(a), FIG. 1(b), and FIG. 1(c) are a schematic diagram of a structure of a wireless headset 100. The wireless headset 100 may be, for example, a TWS Bluetooth headset. The wireless headset 100 may be divided into an earbud portion 1 and an ear handle portion 2. The earbud portion 1 is connected to one end of the ear handle portion 2. The earbud 1 may be accommodated or inserted in a user's pinna, and the ear handle portion 2 may hang from an edge of the user's pinna and located on a periphery of the user's pinna.

As shown in FIG. 1(a) and FIG. 1(c), the ear handle portion 2 may be further divided into a connection segment 21 connected to the earbud portion 1, and a top segment 22 and a bottom segment 23 located on both sides of the connection segment 21. The top segment 22, the connection segment 21, and the bottom segment 23 of the ear handle portion 2 are arranged in order along a longitudinal direction of the wireless headset. In this application, the longitudinal direction may be an extension direction of the ear handle portion 2 (as shown in the Y axis shown in FIG. 1(a)), and a length direction of the ear handle portion 2. Two ends of the longitudinal direction may be a top end and a bottom end. The top segment 22, the connection segment 21, and the bottom segment 23 may be of a one-piece structure or a split structure.

As shown in FIG. 1(b), the ear handle portion 2 may alternatively be divided into the connection segment 21 connected to the earbud portion 1, and a bottom segment 23 located on one side of the connection segment 21. The connection end 21 is connected between the earbud portion 1 and the bottom segment 23. The connection segment 21 and the bottom segment 23 are distributed along the longitudinal direction of the wireless headset 100. That is, in this application. the wireless headset 100 may have or may not have the top segment 22 as shown in FIG. 1(a) and FIG. 1(c).

As shown in FIG. 1(a) and FIG. 1(b), the wireless headset 100 may include a housing 10. The housing 10 may be used to accommodate various components of the wireless headset 100. The housing 10 may include a main housing 101, a bottom housing 102, and a lateral housing 103.

The main housing 101 may cover a part of the bottom segment 23 of the ear handle portion 2, the connection segment 21 of the ear handle portion 2, the top segment 22 of the ear handle portion 2, and a part that is connected to the connection segment 21 and that is in the earbud portion 1. The main housing 101 may form a first opening 1011 at the bottom segment 23 of the ear handle portion 2, and may form a second opening 1012 at the earbud portion 1. The first opening 1011 and the second opening 1012 may be used to pack components of the wireless headset 100.

The bottom housing 102 may be located at the very bottom of the bottom segment 23 of the ear handle portion 2. The bottom housing 102 may be fastened to the main housing 101 through the first opening 1011. In a possible implementation, a connection between the bottom housing 102 and the main housing 101 is a detachable connection (such as a snap-on connection or a threaded connection) for subsequent repair (or maintenance) of the wireless headset 100. In another possible implementation, a connection between the bottom housing 102 and the main housing 101 may be a non-detachable connection (such as a glued connection), to reduce a risk of accidental detachment of the bottom housing 102, which is conducive to improving reliability of the wireless headset 100.

The lateral housing 103 may be located on a side that is of the earbud portion 1 and that is away from the ear handle portion 2. The lateral housing 103 may be fastened to the main housing 101 through the second opening 1012. In a possible implementation, a connection between the lateral housing 103 and the main housing 101 is a detachable connection (such as a snap-on connection or a threaded connection) for subsequent repair (or maintenance) of the wireless headset 100. In another possible implementation, a connection between the lateral housing 103 and the main housing 101 may alternatively be a non-detachable connection (such as a glued connection), to reduce a risk of accidental detachment of the lateral housing 103, which is conducive to improving reliability of the wireless headset 100.

The lateral housing 103 may be provided with one or more sound outlet holes 1031, so that the sound inside the housing 10 may be transmitted to the outside of the housing 10 through the sound outlet hole 1031. This application may not limit shapes, positions, a quantity, and the like of the sound outlet holes 1031.

It should be understood that this application may not limit a quantity and positions of openings on the housing 10. Different wireless headsets 100 may have different quantities and/or positions of openings. For example, as shown in FIG. 1(c), the housing 10 may include a first housing 104 and a second housing 105. A third opening 1041 may be formed on the first housing 104. The first housing 104 may be fastened to the second housing 105 through the third opening 1041. In an example shown in FIG. 1(c), the wireless headset 100 may have a smaller quantity of openings.

It should be understood that the structures of the wireless headset 100 shown in FIG. 1(a), FIG. 1(b), and FIG. 1(c) are only some examples, and the wireless headset 100 may have other different embodiments. The following uses the wireless headset 100 shown in FIG. 1(a). FIG. 1(b), and FIG. 1(c) only as an example for detailed description.

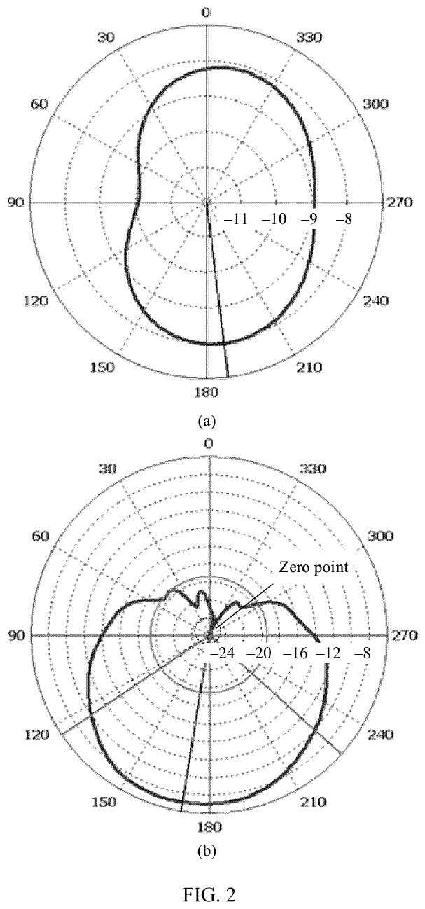

FIG. 2 is a schematic diagram of comparison between patterns of an antenna structure of a TWS headset in different cases. (a) in FIG. 2 is a pattern, of the antenna structure of the TWS headset, generated when a user does not wear the TWS headset, and (b) in FIG. 2 is a pattern, of the antenna structure of the TWS headset, generated when a user wears the TWS headset.

Because the TWS headset is worn on the user's ear and close to the user's head, a human body severely absorbs energy radiated from the antenna structure of the headset, and a pattern of the antenna structure changes. In addition, due to a reflection effect, the antenna structure of the headset generates, on a side close to the human head, a zero point with very poor radiation performance, as shown in (b) in FIG. 2, which causes a stuttering problem during use of the user and reduces user experience. It should be understood that a zero point of a pattern of the antenna structure may be considered as a smaller value of a gain in the pattern of the antenna structure, or may be considered as an area in which a gain in the pattern of the antenna structure is less than a threshold, and the pattern of the antenna structure may also have a plurality of zero points due to different antenna structures and different environments in which the antenna structure is located.

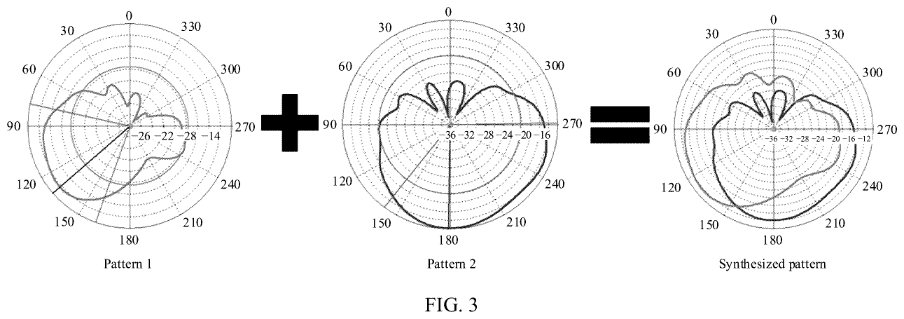

To resolve the above problem, pattern switching is urgently needed for the antenna structure of the headset. The antenna structure provided in embodiments of this application may include an antenna element 1 and an antenna element 2. A pattern, of the antenna element 1, generated when a user wears the headset is a pattern 1 in FIG. 3, a pattern, of the antenna element 2, generated when the user wears the headset is a pattern 2 in FIG. 3, and the pattern 1 and the pattern 2 are two complementary patterns. The headset can switch between the antenna element 1 and the antenna element 2 based on sensitivity of the antenna elements when a packet loss ratio is lower than a threshold, so as to switch between the two complementary patterns. A position of a zero point of an original single antenna pattern is complemented, and a synthesized dual antenna pattern compensates for a small gain of either single antenna pattern at a zero point, thereby improving overall over-the-air (OTA) performance of the antenna structure. It should be understood that two complementary patterns may be understood as that zero points of the two patterns are not in an identical direction, that is, the zero points do not overlap. The packet loss ratio may be understood as a ratio of lost data packets in a process in which an electronic device receives data packets. When the packet loss ratio is greater than the threshold, it may be determined that the current antenna structure is greatly affected by an environment and radiation characteristics of the antenna structure are poor. The synthesized pattern is formed by combining at least two patterns for ease of understanding, and the synthesized pattern may be understood as that a gain of the synthesized pattern at any angle is a larger value of gains that correspond to the angle and that are in the at least two patterns. It should be understood that a synthesized pattern of two complementary patterns may increase a gain of either pattern at least at a zero point.

Currently: an industrial design (ID) trend of a TWS headset on the market is an architecture scheme based on a metal housing. The metal housing is more ornamental in appearance, but brings a large challenge for an antenna design. First, if the metal housing is not configured as a radiator, a formed outer metal layer shields radiation of an antenna structure disposed inside the headset, and performance of the antenna structure deteriorates severely. Second, if the metal housing is configured as a radiator, a product ID limits a cabling form of an antenna structure, and the antenna structure has no optimization variables except matching network adjustment. In addition, due to the limitation of the metal housing, it is even more challenging to implement pattern switching of the antenna structure.

Therefore, with a requirement of the antenna structure in the TWS headset for the pattern switching, the challenge of a metal ID to the pattern switching for the antenna structure, and a market requirement for continuous miniaturization, a design of the pattern switching for the antenna structure of the TWS headset becomes more difficult.

This application provides a wearable device that may include an intelligent dual-antenna structure, and the antenna structure is designed based on a metal housing of the wearable device. Pattern switching can be performed when good radiation characteristics of the antenna structure are ensured, so as to reduce stuttering times generated when a user wears the wearable device, and improve user experience.

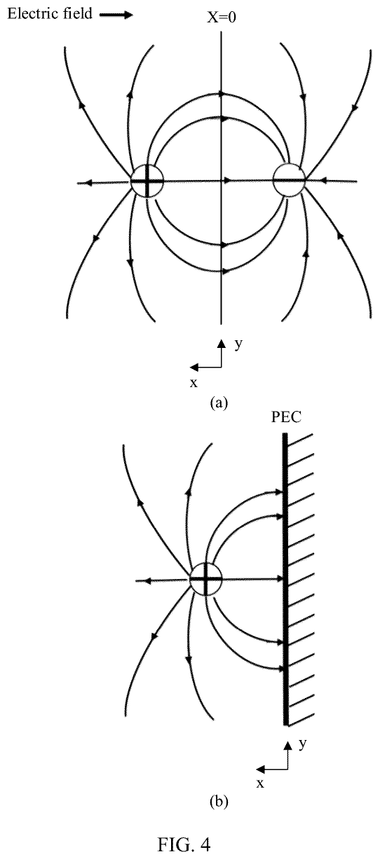

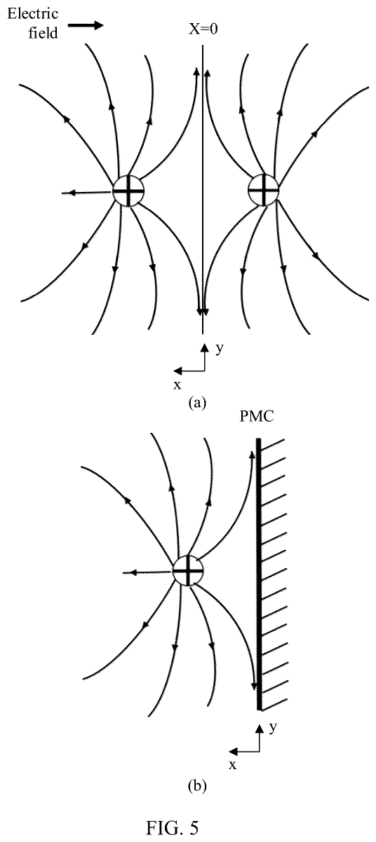

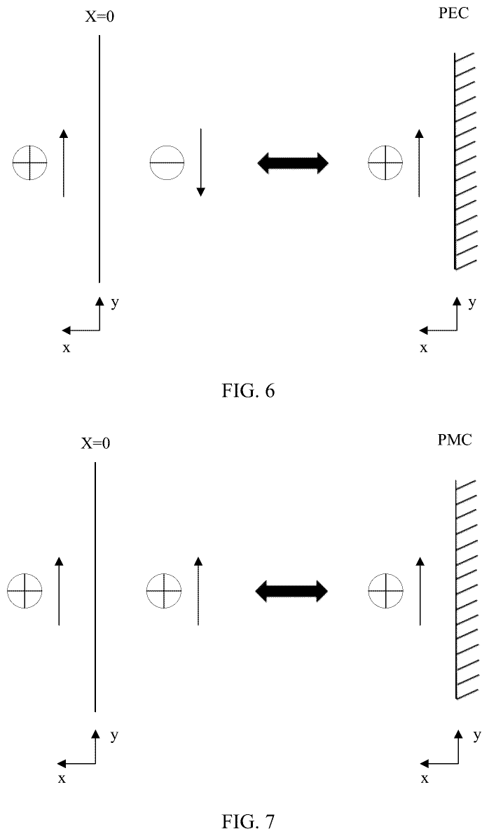

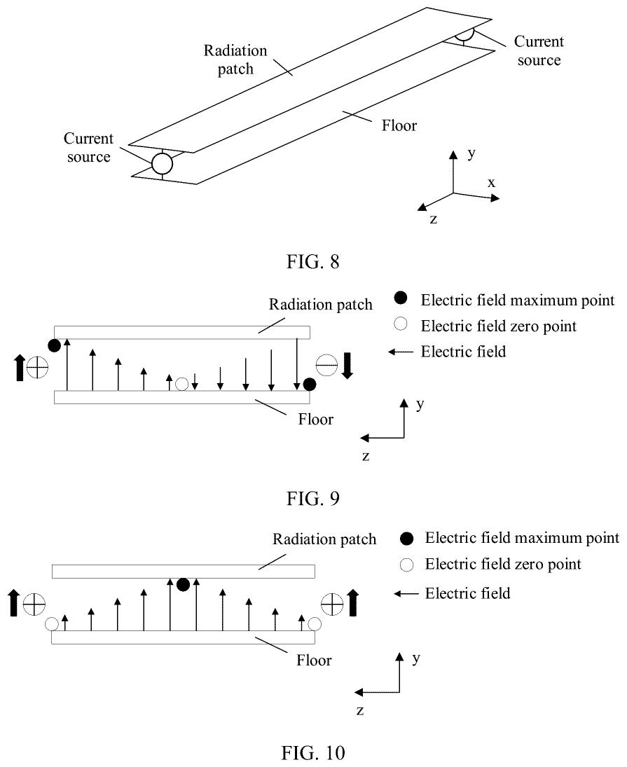

First. FIG. 4 to FIG. 10 describe two basic principles related in this application. FIG. 4 is a schematic diagram of an equivalence principle of anisotropic charges according to this application. FIG. 5 is a schematic diagram of an equivalence principle of isotropic charges according to this application. FIG. 6 is a schematic diagram of an equivalence principle of reverse current sources according to this application. FIG. 7 is a schematic diagram of an equivalence principle of codirectional current sources according to this application. FIG. 8 is a schematic diagram of an antenna structure according to this application. FIG. 9 is a schematic diagram of a principle of differential feeding according to this application. FIG. 10 is a schematic diagram of a principle of in-phase feeding according to this application.

As shown in FIG. 4 to FIG. 7, this application applies the equivalence principle of the codirectional current sources and the equivalence principle of the reverse current sources. For ease of understanding. FIG. 4 and FIG. 5 describe the equivalence principle of the anisotropic charges and the equivalence principle of the isotropic charges.

### 1. Equivalence Principle of the Anisotropic Charges

The anisotropic charges at a distance are placed horizontally, the two charges are disposed on both sides of a straight line X=0), and distances between the two charges and the straight line X=0 are the same. Electric fields generated by the two charges in space are shown in (a) in FIG. 4. The electric fields generated by the two charges in space are perpendicular to the straight line X=0). A perfect electric conductor (PEC) is defined as follows: On a surface of the perfect electric conductor, all electric fields are perpendicular to the PEC, as shown in (b) in FIG. 4. Therefore, electromagnetic fields generated by the two charges in space (X>0) shown in (a) in FIG. 4 (or in space X<0 not shown in the figure) can be equivalent to an electromagnetic field generated, on a PEC disposed at X=0, by one charge in space shown in (b) in FIG. 4, which may be referred to as a mirror principle.

### 2. Equivalence Principle of the Isotropic Charges

The isotropic charges at a distance are placed horizontally, the two charges are disposed on both sides of a straight line X=0, and distances between the two charges and the straight line X=0 are the same. Electric fields generated by the two charges in space are shown in (a) in FIG. 5. The electric fields generated by the two charges in space are parallel to the straight line X=0). Because an electric field is perpendicular to a magnetic field, magnetic fields generated by the two charges in space is perpendicular to the straight line X=0. A perfect magnetic conductor (PMC) is defined as follows: On a surface of the perfect magnetic conductor, all magnetic fields are perpendicular to the PMC (all electric fields are perpendicular to the PMC), as shown in (b) in FIG. 5. Therefore, electromagnetic fields generated by the two charges in space (X>0) shown in (a) in FIG. 5 (or in space X<0), not shown in the figure) can be equivalent to an electromagnetic field generated, on a PMC disposed at X=0, by one charge in space shown in (b) in FIG. 5, which may be referred to as a mirror principle.

Similar to the equivalence principle of the anisotropic charges and the equivalence principle of the isotropic charges, an equivalence principle of reverse current sources and an equivalence principle of codirectional current sources are described in FIG. 6 and FIG. 7.

### 3. Equivalence Principle of the Reverse Current Sources

Similar to the equivalence principle of the anisotropic charges, the reverse current sources at a distance are placed horizontally, the two current sources are disposed on both sides of a straight line X=0), and distances between the two current sources and the straight line X=0) are the same. According to a mirror principle, electromagnetic fields generated by the reverse current sources in space (X>0 (or in space X<0), not shown in the figure) are equivalent to an electromagnetic field generated, on a PEC disposed at X=0, by one current source in space shown in FIG. 6.

### 4. Equivalence Principle of the Codirectional Current Sources

Similar to the equivalence principle of the isotropic charges, the codirectional current sources at a distance are placed horizontally, the two current sources are disposed on both sides of a straight line X=0 and distances between the two current sources and the straight line X=0) are the same. According to a mirror principle, electromagnetic fields generated by the codirectional current sources in space (X>0 (or in space X<0 not shown in the figure) are equivalent to an electromagnetic field generated, on a PMC disposed at X=0, by one current source in space shown in FIG. 7.

FIG. 9 and FIG. 10 are schematic diagrams of a principle of differential/in-phase feeding. The principle, of differential/in-phase feeding, shown in FIG. 9 and FIG. 10 is based on the antenna structure shown in FIG. 8. The antenna structure shown in FIG. 8 is a patch antenna with a radiation patch whose electrical length is ½λ, and current sources are electrically connected to the patch antenna at two ends of the antenna structure to perform feeding.

### 1. Principle of Differential Feeding

A feeding manner shown in FIG. 9 is differential feeding, where the current sources at the two ends of the antenna structure are in reverse directions (where amplitudes of electrical signals are the same, and a phase difference is 180°), and a radiation pattern of the antenna structure has a largest radiation value in a y-axis direction and generates a zero point in a z-axis direction.

### 2. Principle of In-Phase Feeding

A feeding manner shown in FIG. 10 is in-phase feeding, where the current sources at the two ends of the antenna structure are in an identical direction (where amplitudes of electrical signals are the same, and a phase difference is 0°), and a radiation pattern of the antenna structure has a largest radiation value in a z-axis direction and generates zero points in a y-axis direction.

Therefore, for the antenna structure shown in FIG. 8, a corresponding pattern generated when in-phase feeding is used for the antenna structure and a corresponding pattern generated when differential feeding is used for the antenna structure are orthogonal and complementary. That patterns are orthogonal may be understood as: Directions in which largest radiation values of the two patterns are located are orthogonal. That patterns are complementary may be understood as: Directions in which zero points of the two patterns are located are different.

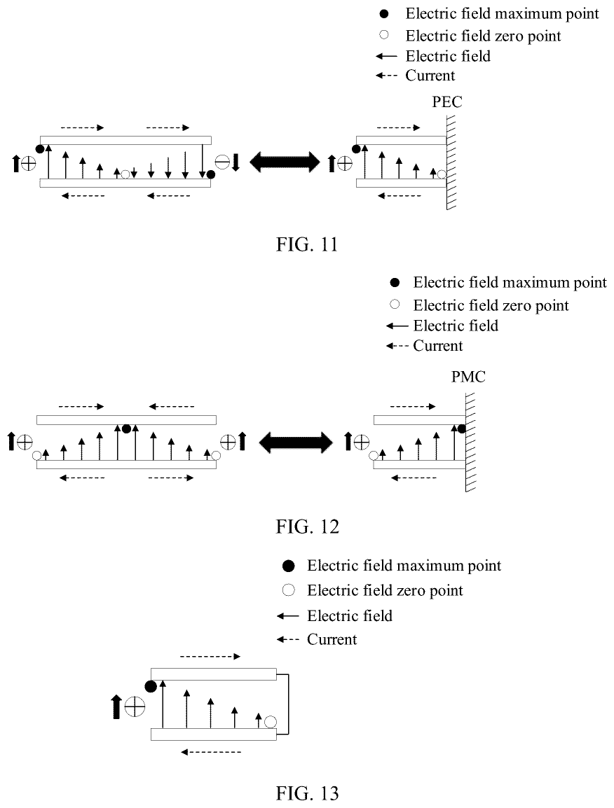

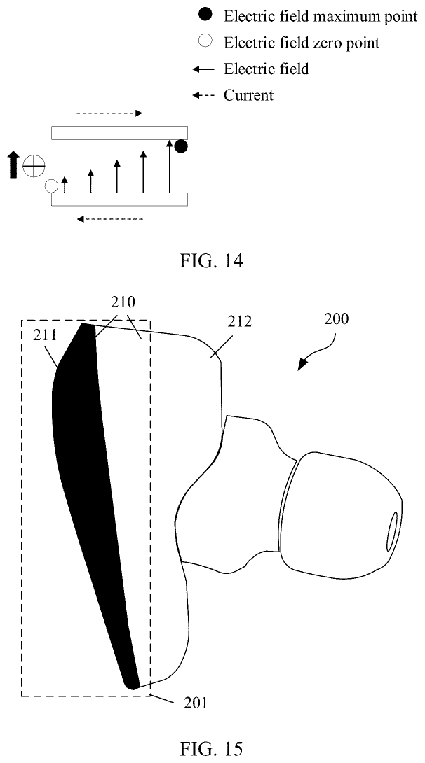

FIG. 11 to FIG. 14 are schematic diagrams of equivalent/simulated electromagnetic fields according to embodiments of this application. FIG. 11 is a schematic diagram in which an equivalence principle of reverse current sources is used. FIG. 12 is a schematic diagram in which an equivalence principle of codirectional current sources is used. FIG. 13 is a simulated schematic diagram of differential feeding. FIG. 14 is a simulated schematic diagram of in-phase feeding.

As shown in FIG. 11, the equivalence principle of the reverse current sources is used. A patch antenna with a radiation patch whose electrical length is ¼λ is electrically connected to a current source at one end of the patch antenna, and a PEC is disposed at the other end. An electromagnetic field of the patch antenna may be equivalent to an electromagnetic field generated in the differential feeding shown in FIG. 9. However, because the PEC cannot be obtained in actual application, the end that is of the patch antenna and at which the PEC is disposed may be electrically connected to a floor to perform electromagnetic field simulation, so that a similar effect may be obtained, and electric field distribution of such a structure is shown in FIG. 13.

As shown in FIG. 12, the equivalence principle of the codirectional current sources is used. A patch antenna with a radiation patch whose electrical length is ¼λ is electrically connected to a current source at one end of the patch antenna, and a PMC is disposed at the other end. An electromagnetic field of the patch antenna may be equivalent to an electromagnetic field generated in the in-phase feeding shown in FIG. 10. However, because the PMC cannot be obtained in actual application, the end that is of the patch antenna and at which the PMC is set may not be electrically connected to a floor (which means an open circuit) to perform electromagnetic field simulation, so that a similar effect may be obtained, and electric field distribution of such a structure is shown in FIG. 14.

FIG. 15 is a schematic diagram of a structure of a wearable device 200 according to an embodiment of this application. An example is used in which the wearable device is a headset.

As shown in FIG. 15, a housing 210 of the wearable device 200 may include a metal portion 211 and a non-metal portion 212.

It should be understood that the wearable device 200 may be a wearable device designed based on an architecture scheme of a metal housing. In order to ensure radiation characteristics of an antenna structure in the wearable device 200, the housing 210 may be a housing formed by splicing metal and an insulation material.

In an embodiment, in order to ensure that the appearance of the wearable device 200 is more ornamental, the metal portion 211 may be disposed on the outside (a side that is of the housing 210 and that is away from a user when the user wears the wearable device) of the housing 210.

The metal portion 211 may be configured as a radiator of an antenna structure 201. The metal portion of the housing 210 is configured as the radiator of the antenna structure 201, so that it can be ensured that the antenna structure 201 in the wearable device 200 obtains a large headroom (away from a PCB/floor/battery/component) and generates good radiation performance.

As shown in FIG. 15, a cavity formed by the housing 210 may further include a plurality of components like a battery, a printed circuit board (PCB), and a speaker. The battery and PCB may be disposed in an ear handle portion of the wearable device 200, and the speaker may be disposed at an earbud portion of the wearable device 200.

The PCB may be a dielectric board made of a flame-retardant material (FR-4), may be a dielectric board made of Rogers, may be a mixture dielectric board made of Rogers and FR-4, or the like. Herein, the FR-4 is a name for a grade of flame-retardant materials, and the dielectric board made of Rogers is a high-frequency board. A metal layer may be disposed in the printed circuit board PCB, and the metal layer may be formed by etching metal on a surface of the PCB. The metal layer may be used to ground an electronic component carried on the PCB, to prevent electric shock on the user or damage to the device. This metal layer may be called the floor.

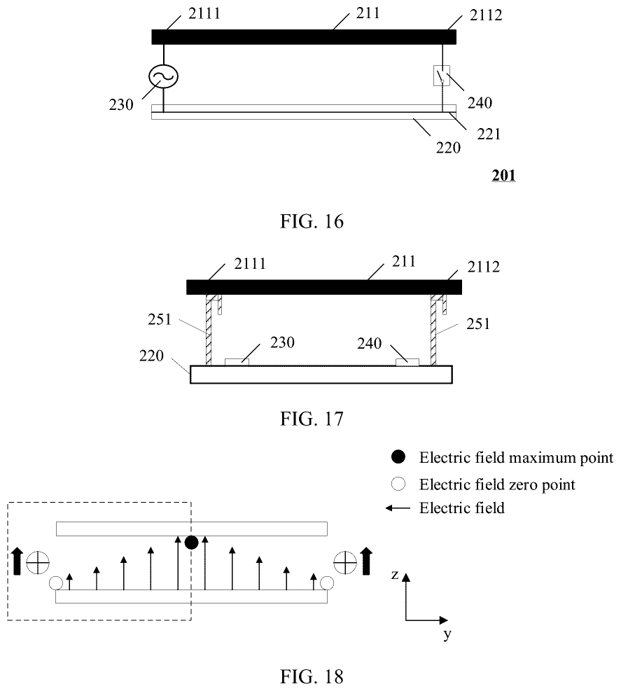

FIG. 16 is a schematic diagram of an antenna structure 201 (also referred to as antenna 201) according to an embodiment of this application.

As shown in FIG. 16, the antenna structure 201 may include a radiator 211, a PCB 220, a feeding unit 230, and a switch 240.

The radiator 211 may be formed by a metal portion 211. The metal portion 211 may be disposed opposite to the PCB 220, and “disposed opposite to” may be understood as: The metal portion 211 and the PCB 220 are disposed face to face. One end of the feeding unit 230 is electrically connected to a first end 2111 of the metal portion 211 and feeds the radiator of the antenna structure 201. One end of the switch 240 is electrically connected to a second end 2112 of the metal portion 211, and the other end of the switch 240 is grounded. The switch 240 has a first switch state and a second switch state. The switch 240 may switch between the first switch state and the second switch state. When the switch 240 is in the first switch state or the second switch state, an operating frequency band of the antenna structure 201 includes a first frequency band.

In an embodiment of this application, the PCB 220 may include a metal layer 221 that is configured as a ground plane/floor of the antenna structure 201, or the metal layer 221 may be electrically connected to a floor and equivalent to the floor of the antenna structure. The other end of the feeding unit 230 is electrically connected to the metal layer 221 for grounding. That the other end of the switch 240 is grounded may be understood as: The other end of the switch 240 is electrically connected to the metal layer 221.

In an embodiment of this application, the feeding unit 230 and the switch 240 may be disposed on an identical substrate (such as the PCB 220), or may alternatively be disposed on two or more different substrates based on a layout requirement, for example, disposed on a PCB other than the PCB 220, and/or a flexible printed circuit (FPC). This is not limited in this application, and may be adjusted based on an actual design.

In an embodiment of this application, the antenna 201 may be used in a wearable device. That the metal portion 211 and the PCB 220 that are of the wearable device are disposed face to face may include: The PCB 220 and the metal portion 211 face each other and are disposed at an interval, and in a direction perpendicular to a plane on which the PCB 220 is located, the PCB 220 is completely projected to the metal portion 211, or the metal portion 211 is completely projected to the PCB 220. In another embodiment of this application, the PCB 220 and the metal portion 211 face each other and are disposed at an interval, the PCB 220 or the metal portion 211 is not completely projected to each other, and the metal portion 211 and the PCB 220 may be partially projected or partially overlap in a direction perpendicular to a plane on which the PCB 220 is located, where for example, an overlapping area may exceed 75% of a total area. In addition, a length direction of the metal portion 211 and/or a length direction of the PCB 220 may be parallel to a length direction of a housing of the wearable device, or offset by +45° relative to a length direction of a housing of the wearable device. For example, the length direction of the metal portion 211 and/or the length direction of the PCB 220 may be parallel to a length direction of the main housing 101 of the TWS headset shown in FIG. 1(a), FIG. 1(b), and FIG. 1(c), or offset by ±45°.

In an embodiment of this application, a length of the metal portion 211 and a length of the PCB 220 may be the same or similar. For example, the length of the metal portion 211 and the length of the PCB 220 are within a (¼± 1/16) range of a first wavelength. Alternatively, a difference between a length of the metal portion 211 and a length of the PCB 220 may be within a range. For example, the difference between the two lengths may be less than one-eighth of a first wavelength. The length of the metal portion 211 may be a physical length in a first direction, the first direction is an extension direction of a virtual connection line between a connection between the feeding unit 230 and the metal portion 211, and a connection between the switch 240 and the metal portion 211. The length of the PCB 220 may be a physical length in the first direction, or may be an extension direction of a virtual connection line of a connection of the PCB 220 and the metal portion 211. As the lengths of the metal portion 211 and the PCB 220 are closer, radiation characteristics of the antenna structure are also better. The first wavelength is a wavelength corresponding to the operating frequency band of the antenna structure 201. For example, the first wavelength may be a wavelength corresponding to a resonance point in the operating frequency band, or may alternatively be a wavelength corresponding to center frequency of the operating frequency band or a supported frequency band, or a wavelength corresponding to the first frequency band. For example, the first wavelength may be a wavelength corresponding to center frequency of the first frequency band.

According to the technical solution of embodiments of this application, the first end 2111 of the metal portion 211 cannot be narrowly understood as necessarily a point, and may alternatively be considered to be a segment of a radiator that includes a first endpoint and that is on the metal portion 211 (where an endpoint of the metal portion 211 may be any point on an edge of the metal portion 211). For example, the first end 2111 may be considered as a radiator within one-eighth of the first wavelength from the first endpoint, or may alternatively be considered as a radiator within 5 mm from the first endpoint. The second end 2112 of the metal portion 211 may also be understood accordingly.

It should be understood that in the technical solution provided in this application, the switch 240 switches electrical connection states between the metal layer 221 and the second end of the metal portion 211, so that different operating modes of the antenna radiator in the first frequency band can be implemented. It may be considered that the radiator 211 in different operating modes corresponds to different antenna elements, for example, including a first antenna element and a second antenna element. The first antenna element and the second antenna element share the radiator 211. When the switch 240 is in the first switch state (such as closed), the second end 2112 of the metal portion 211 and the metal layer 221 are in a first connection state (such as an electrically connected state), the second end of the metal portion is grounded through a first switch, and some or all of the metal portion 211 are configured as the radiator of the first antenna element. In this case, the first element may be a left-handed antenna or a loop antenna. When the feeding unit 230 performs feeding, an electromagnetic field generated by the first antenna element is similar to the electromagnetic field generated by the differential feeding shown in FIG. 9. When the switch 240 is in the second switch state (such as open), the second end 2112 of the metal portion 211 and the metal layer 221 are in a second connection state (where for example, the second end 2112 of the metal portion 211 and the metal layer 221 are not connected, in other words, no electrical connection is formed, and transmission of an electrical signal is not performed), the second end of the metal portion is not grounded through the first switch, and some or all of the metal portion 211 are configured as the radiator of the second antenna element. In this case, the second element may be a monopole antenna. When the feeding unit 230 performs feeding, an electromagnetic field generated by the second antenna element is similar to the electromagnetic field generated by the in-phase feeding shown in FIG. 10. Therefore, by controlling the states of the switch 240, the antenna structure 201 can be controlled to switch between the first antenna element and the second antenna element. Both the first antenna element and the second antenna element use the metal portion 211 as the radiator to generate radiation. Because patterns of the first antenna element and the second antenna element are complementary, the patterns may be switched by switching between the two antenna elements when a packet loss ratio is lower than a threshold. Therefore, coverage of a pattern of the antenna structure 201 is increased (where for example. 360° omnidirectional coverage is implemented), so as to implement a stable connection of an antenna signal and improve user experience. Therefore, when the first switch switches to the first switch state or the second switch state, the operating frequency band of the antenna structure 201 includes the first frequency band, in other words, resonances generated by the first antenna element and the second antenna element both can support the wearable device in communicating in the first frequency band. In an embodiment of this application, operating frequency bands of the first antenna element and the second antenna element are co-frequency. In an embodiment of this application, the first antenna element and the second antenna element have different patterns. By switching between the states of the first switch, the pattern of the antenna structure 201 can be changed.

It should be understood that, that operating frequency bands of the first antenna element and the second antenna element are co-frequency may be understood as any one of the following cases.

1. The operating frequency band of the first antenna element and the operating frequency band of the second antenna element include an identical communication frequency band. For example, if the operating frequency band of the first antenna element and the operating frequency band of the second antenna element both include the first frequency band, it may be considered that the first antenna element and the second antenna element are co-frequency. The first frequency band may be a Bluetooth frequency band. The first frequency band may alternatively be a sub-6G frequency band in 5G.

2. There is a partially overlapping frequency band in the operating frequency band of the first antenna element and the operating frequency band of the second antenna element. For example, the operating frequency band of the first antenna element includes B35 (1.85 to 1.91 GHz) in LTE, the operating frequency band of the second antenna element includes B39 (1.88 to 1.92 GHZ) in LTE, and the operating frequency band of the first antenna element and the operating frequency band of the second antenna element partially overlap. In this case, it may be considered that the first antenna element and the second antenna element are co-frequency.

In embodiments of this application, the first antenna element and the second element share the same radiator, so as to reduce a volume of the antenna structure. In actual application, antenna elements formed by sharing a radiator may each be a monopole, a dipole, a loop antenna an inverted F antenna (IFA), or the like. This is not limited in this application.

In an embodiment of this application, the metal portion 211 may be a part of the housing or may be separated from the housing. For example, the metal portion 211 may be disposed or formed on an inner/outer surface of the housing, or the metal portion 211 may be disposed inside the housing and separated from the housing.

When the metal portion 211 is a part of the housing and the housing is made of metal, an entire housing may be configured as the metal portion, or a part or all, of the housing, enclosed by an insulation material may be configured as the metal portion 211, for example, the main housing 101/second housing 105 of the TWS headset shown in FIG. 1(a), FIG. 1(b), and FIG. 1(c). The housing may alternatively be as follows: A part is made of metal (serving as the metal portion 211) and a part is made of an insulation material. To ensure a uniform surface, an identical insulation material may be disposed on the outside of the metal.

When the metal portion 211 is disposed or formed on the inner/outer surface of the housing, the metal portion 211 may be the surface (a user visible portion) of the wearable device, or may alternatively be provided on the surface (inner surface or outer surface) of the housing of the wearable device through a patch or a laser-direct-structuring (LDS) technology.

When the metal portion is disposed in internal space enclosed by the housing, the metal portion 211 may be implemented by a metal layer or a metal patch, for example, floating metal (FLM), a flexible printed circuit (FPC), an internal conductor/structure, or a PCB on-board. This is not limited in this application.

In an embodiment, an electrical length of the metal portion 211 may be one-quarter of the first wavelength. In actual production, there may be processing errors, or environmental interference. Therefore, the electrical length of the metal portion 211 may be set as about one-quarter of the first wavelength, for example, may be set in a range of plus or minus one-sixteenth of the first wavelength. In addition, the electrical length of the metal portion 211 may be understood as an electrical length converted from a distance between an endpoint of the first end 2111 and the connection between the switch 240 and the metal portion 211. For the electrical length of the metal portion 211, a position of the connection between the switch 240 and the metal portion 211 may affect a value of the electrical length of the metal portion 211, and a capacitor and/or an inductor loaded on the metal portion 211 may also affect a value of the electrical length of the metal portion 211. For example, a capacitor or an inductor disposed between the switch 240 and the metal portion 211 may change the electrical length of the metal portion 211 (where for example, loading a capacitor increases the electrical length, and loading an inductor reduces the electrical length). The electrical length may be expressed by multiplying a physical length (namely, mechanical length or geometric length) by a ratio of a transmission time period of an electrical or electromagnetic signal in a medium to a time period required by this signal to travel, in free space, for a distance that is the same as the physical length of the medium, and the electrical length may satisfy the following formula:

$$\overline{L} = L \times \frac{a}{b}$$

L is the physical length, a is the transmission time period of the electrical or electromagnetic signal in the medium, and b is the transmission time period in free space.

Alternatively, the electrical length may be a ratio of a physical length (namely, mechanical length or geometric length) to a wavelength of an electromagnetic wave in transmission, and the electrical length may satisfy the following formula:

$$\overline{L} = \frac{L}{λ}$$

L is the physical length, and λ is the wavelength of the electromagnetic wave.

It should be understood that because an equivalence principle of reverse current sources and an equivalence principle of codirectional current sources are used in the technical solution used in this application, the electrical length of the radiator (metal portion) of the antenna structure is reduced by half compared with that in an antenna structure for which the equivalent principles are not used. This is more conducive to miniaturization of the antenna structure and is more suitable for an increasingly thin wearable device.

In an embodiment, the distance between the connection between one end of the feeding unit 230 and the metal portion 211, and the connection between the switch 240 and the metal portion 211 may be greater than or equal to one-eighth of the first wavelength, so as to ensure the radiation characteristics of the antenna structure 201.

In an embodiment, the operating frequency band of the antenna structure 201 may include a communication frequency band that may be used by the wearable device to have a communication connection with other electronic devices. It should be understood that the electrical length of the metal portion 211 may also be adjusted to enable the operating frequency band of the antenna structure 201 to include other communication frequency bands.

In an embodiment, the feeding unit 230 may be a radio frequency channel in a radio frequency chip inside the electronic device.

In an embodiment, the switch 240 may be a single-pole single-throw switch, or switches of other types, for example, a single-pole double-throw switch, a single-pole four-throw switch, or a four-pole single-throw switch, which may also implement an identical technical effect, or may alternatively be components of other types, for example, an adjustable capacitor. The electrical connection states between the metal layer 221 and the metal portion 211 are switched by changing a capacitance value of the adjustable capacitor. The adjustable capacitor may include a first capacitance state and a second capacitance state, respectively corresponding to the first switch state and the second switch state of the switch 240, the first capacitance state corresponds to a first capacitance value, the second capacitance state corresponds to a second capacitance value, and setting of the first capacitance value and the second capacitance value is related to operating frequency of the antenna structure. For the Bluetooth frequency band (2.4 to 2.485 GHZ), when the first capacitance value of the adjustable capacitor in the first capacitance state is less than or equal to 0.2 pF, it may be considered that the second end 2112 of the metal portion 211 is not connected to the metal layer 221. When the second capacitance value of the adjustable capacitor in the second capacitance state is greater than or equal to 10 pF, it may be considered that the second end 2112 of the metal portion 211 is electrically connected to the metal layer 221. It should be understood that in different frequency bands, capacitance values corresponding to the electrical connection state (disconnected or connected) between the metal layer 221 and the metal portion 211 are different. Therefore, for other frequency bands, an identical effect can also be achieved by adjusting a capacitance value of the adjustable capacitor. This is not limited in this application.

The adjustable capacitor is an adjustable capacitor whose capacitance value can be adjusted within a range. A capacitance value of a capacitor is calculated as follows:

$$C = \frac{ε S}{4 π k d} ,$$

where

ε is a dielectric constant between two plates: δ is an absolute permittivity in a vacuum: k is an electrostatic force constant: S is an area in which the two plates are directly opposite to each other; and d is a vertical distance between the two plates.

Therefore, a principle of the adjustable capacitor is generally to change the area in which the two plates of the capacitor are directly opposite to each other or the vertical distance between the two plates, so as to change the capacitance value accordingly.

It should be understood that FIG. 16 is only a schematic diagram. In actual application, the feeding unit 230 and the switch 240 may be disposed on the PCB 220, and respectively electrically connected to the first end 2111 and the second end 2112 of the metal portion 211 through metal springs 251 and 252, as shown in FIG. 17. Therefore, a distance between the metal portion 211 and the PCB 220 may be about the heights of the metal springs 251 and 252. For example, the distance between the metal portion 211 and the PCB 220 may be about 1.5 mm, and may be adjusted based on an actual design. This is not limited in this application.

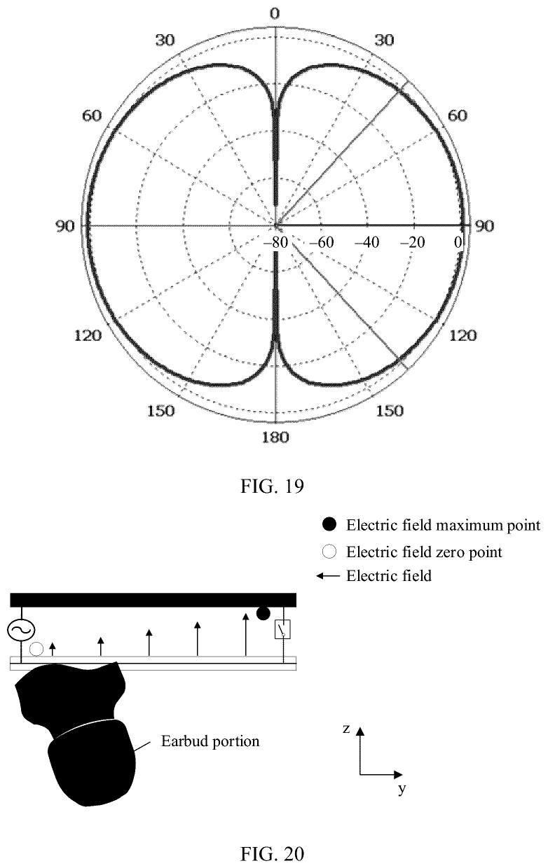

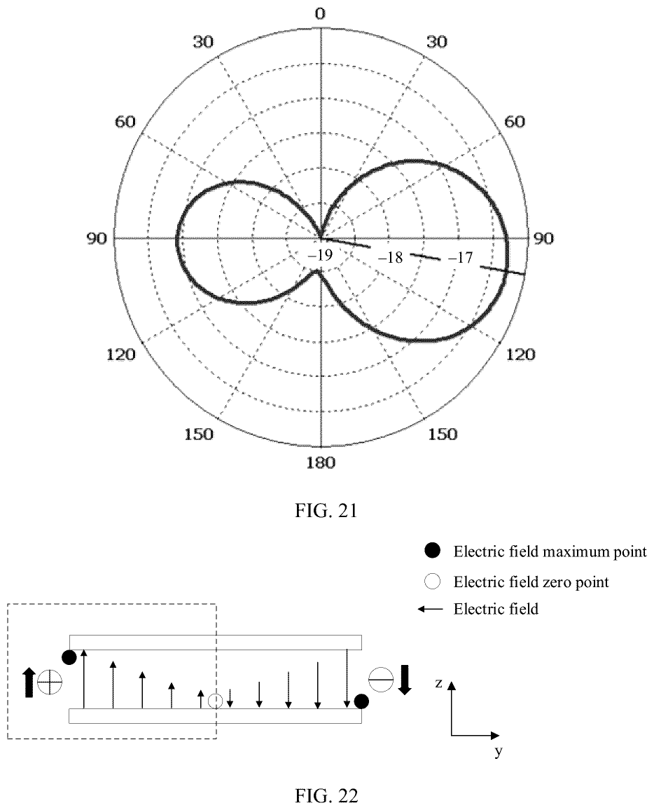

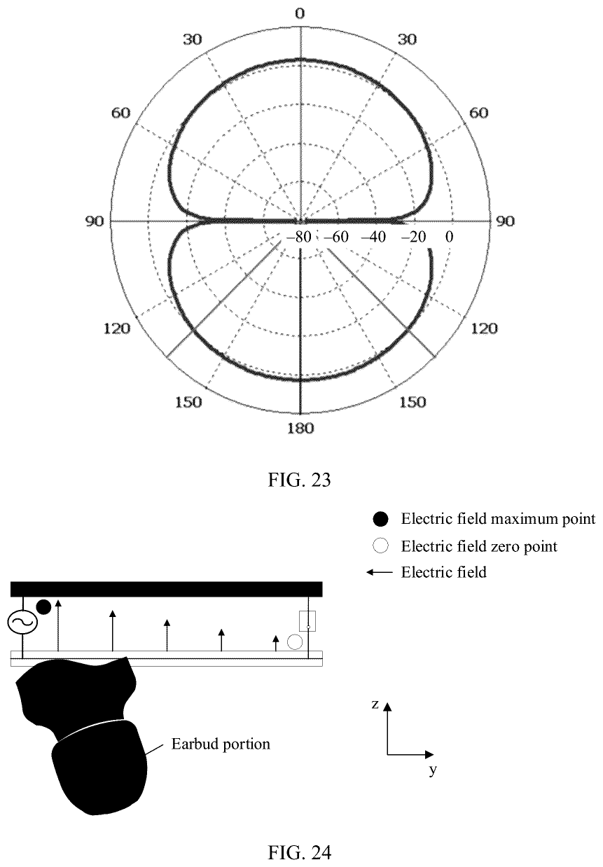

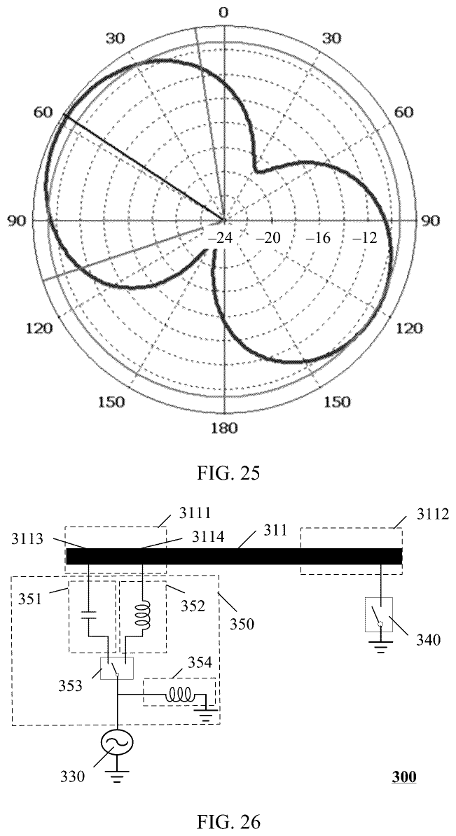

FIG. 18 to FIG. 25 are schematic diagrams of electric field distribution and patterns according to embodiments of this application. FIG. 18 is a schematic diagram of electric field distribution generated when in-phase feeding is performed on a control group according to this application. FIG. 19 is a pattern generated when in-phase feeding is performed on a control group according to this application. FIG. 20 is a schematic diagram of electric field distribution generated when the switch in the antenna structure shown in FIG. 16 is in a second switch state, such as open, according to this application. FIG. 21 is a pattern generated when the switch in the antenna structure shown in FIG. 16 is in a second switch state, such as open, according to this application. FIG. 22 is a schematic diagram of electric field distribution generated when differential feeding is performed on a control group according to this application. FIG. 23 is a pattern generated when differential feeding is performed on a control group according to this application. FIG. 24 is a schematic diagram of electric field distribution generated when the switch in the antenna structure shown in FIG. 16 is in a first switch state, such as closed, according to this application. FIG. 25 is a pattern generated when the switch in the antenna structure shown in FIG. 16 is in a first switch state, such as closed, according to this application.

It should be understood that an antenna structure of the control group used in this embodiment is the antenna structure shown in FIG. 8, the antenna structure shown in FIG. 8 is a patch antenna with a radiation patch whose electrical length is ½λ, and a feeding unit (a current source) is electrically connected to the patch antenna at two ends of the antenna structure for performing feeding.

As shown in FIG. 20, the antenna structure has a smallest electric field at a feeding unit and a largest electric field at the switch. FIG. 21 is the pattern generated when the switch in the antenna structure is open, and there is a smallest gain along a z-axis direction and a largest gain along a y-axis direction.

In the control group, the antenna structure adopts in-phase feeding, and electric field distribution of the antenna structure is shown in FIG. 18. Because an electric length of an antenna structure corresponding to FIG. 18 is only one-half of that of the antenna structure of the control group, the electric field distribution of the antenna structure shown in FIG. 20 is similar to the left electric field distribution of the control group. As shown in FIG. 19, directions of a largest value of a gain and a zero point of the pattern of the control group are consistent with those of the antenna structure corresponding to FIG. 21.

As shown in FIG. 24, the antenna structure has a largest electric field at a feeding unit and a smallest electric field at the switch. FIG. 25 is the pattern generated when the switch in the antenna structure is closed. In an original design, there is a largest gain along a z-axis direction and a smallest gain along a y-axis direction. However, due to asymmetry (an earbud portion part) of the wearable device, directions of a largest value of the gain and a zero point are offset from the original directions.

In the control group, the antenna structure adopts differential feeding, and electric field distribution of the antenna structure is shown in FIG. 22. Because an electric length of the antenna structure corresponding to FIG. 24 is only one-half of that of the antenna structure of the control group, the electric field distribution of the antenna structure shown in FIG. 24 is similar to the left electric field distribution of the control group. As shown in FIG. 23, directions of a largest value of a radiation gain and a zero point of the pattern of the control group are similar to those of the antenna structure corresponding to FIG. 25.

FIG. 26 is a schematic diagram of an antenna structure 300 according to an embodiment of this application.

As shown in FIG. 26, the antenna structure 300 may further include a matching network 350. The matching network 350 may include a first radio frequency circuit 351, a second radio frequency circuit 352, and a second switch 353. A first feeding point 3113 and a second feeding point 3114 may be set at a first end 3111 of a metal portion 311, and a distance between the first feeding point 3113 and the second feeding point 3114 may be less than one-sixteenth of a first wavelength. In an embodiment of this application, the distance between the first feeding point 3113 and the second feeding point 3114 may be less than or equal to 2 mm, or less than or equal to 1 mm. For example, a distance between an edge of a spring connecting to the first feeding point 3113 and an edge of a spring connecting to the second feeding point 3114 may be less than or equal to 2 mm, or less than or equal to 1 mm. In an embodiment of this application, the first feeding point 3113 and the second feeding point 3114 may be disposed along a length direction of the metal portion 311 at an interval, or may be disposed along a width direction of the metal portion 311 at an interval. In other words, a connection line between the first feeding point 3113 and the second feeding point 3114 may intersect with or be approximately perpendicular (approximately) 90° to the length direction of the metal portion 311. One end of the first radio frequency circuit 351 is electrically connected to the metal portion 311 at the first feeding point 3113, and the other end of the first radio frequency circuit 351 is electrically connected to the second switch 353. One end of the second radio frequency circuit 352 is electrically connected to the metal portion 311 at the second feeding point 3114, and the other end of the second radio frequency circuit 352 is electrically connected to the second switch 353. The second switch 353 may be electrically connected to a feeding unit 330, and the second switch 353 is used to switch between the first radio frequency circuit 351 and the second radio frequency circuit 352.

In an embodiment, the matching network 350 further includes a third radio frequency circuit 354. One end of the third radio frequency circuit 354 is connected and placed between the second switch 353 and the feeding unit 330, and the other end of the third radio frequency circuit 354 is electrically connected to a metal layer (floor).

It should be understood that when a first switch 340 is closed, a second end 3112 of the metal portion 311 is electrically connected to the metal layer (floor), to form a first antenna element. When the first switch 340 is open, the second end 3112 of the metal portion 311 is not connected to the metal layer (floor), to form a second antenna element. The first switch 340 is used to switch between two states (disconnected and grounded) of the second end 3112 of the metal portion 311, and the second switch 353 may be used to switch matching of the first antenna element and the second antenna element, for example, through frequency tuning. In order to prevent reactances of matching networks from affecting each other during switching, reactances (a reactance of the first radio frequency circuit 351 and a reactance of the second radio frequency circuit 352) that are connected in series and that correspond to the two antenna elements may be switched via the second switch 353. In addition, a reactance (a reactance of the third radio frequency circuit 354) that is connected in parallel may be placed between the second switch 353 and the feeding unit 330 rather than between the feeding point and the second switch 353, which not only ensures a switching effect of the second switch 353 on the matching networks, but also prevents the reactances, of different matching networks corresponding to the first antenna element and the second antenna element, from affecting each other, and can reduce a layout of electronic components.

In an embodiment, the first radio frequency circuit 351 may be electrically connected to the metal portion 311 at the first feeding point 3113 via the metal spring. The second radio frequency circuit 352 may be electrically connected to the metal portion 311 at the second feeding point 3114 via the metal spring.

In an embodiment, the matching network and the feeding unit 230 and/or a switch 240 may be disposed on an identical substrate such as a PCB 220, or disposed on two or more different substrates. Different substrates may include a PCB, and/or an FPC. This is not limited in this application, and may be adjusted based on an actual design.

In an embodiment, the first radio frequency circuit 351 includes a first capacitor, the second radio frequency circuit 352 includes a first inductor, and the third radio frequency circuit 354 includes a second inductor. For the antenna structure 300, the first capacitor is connected in series between the first end 3111 of the metal portion 311 and the second switch 353, the first inductor is connected in series between the first end 3111 of the metal portion 311 and the second switch 353, and the second inductor is connected in parallel between the second switch 353 and the feeding unit 330.

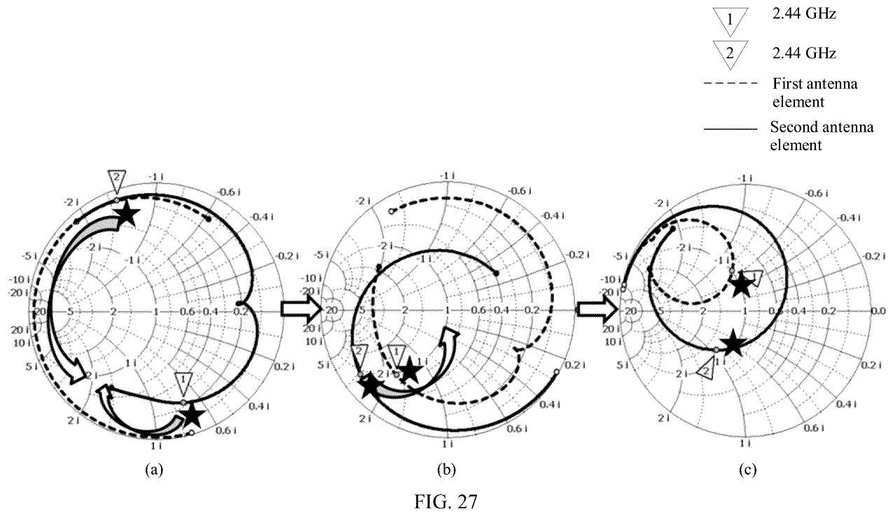

It should be understood that the first capacitor and the second inductor may be used to match the first antenna element to optimize radiation characteristics of the first antenna element. The first inductor and the second inductor may be used to match the second antenna element, to optimize radiation characteristics of the second antenna element. A chart of (a) in FIG. 27 shows initial positions (at the second and fourth quadrants) that are on the Smith chart and that are of reflectivity coefficients of the first antenna element and the second antenna element without the matching networks. If the appropriate first capacitor (first radio frequency circuit) is connected in series with the first antenna element and the appropriate first inductor (second radio frequency circuit) is connected in series with the second antenna element, positions of operating frequency bands of the first antenna element and the second antenna element may be adjusted and located in an equal impedance circle, as shown in the chart of (b) in FIG. 27. Finally, the second inductor (third radio frequency circuit) is connected in parallel, so that the positions of the operating frequency bands of the first antenna element and the second antenna element may be adjusted and located near a circle center, as shown in the chart of (c) in FIG. 27. Because the first antenna element and the second antenna element share the second inductor (third radio frequency circuit) for matching, a layout of electronic components is reduced.

In an embodiment, a capacitance value of the first capacitor is between 0.5 pF and 1.5 pF, an inductance value of the first inductor is between 1 nH and 2 nH, and an inductance value of the second inductor is between 1 nH and 2 nH. It should be understood that in this application, the Bluetooth frequency band is used only as an example. When an operating frequency band of the antenna structure changes, the capacitance value of the first capacitor, the inductance value of the first inductor, and the inductance value of the second inductor may be adjusted.

In an embodiment, the capacitance value of the first capacitor may be 1 pF, the inductance value of the first inductor may be 1.5 nH, and the inductance value of the second inductor may be 1.5 nH. It should be understood that in an actual production design, specific data of the first capacitor, the first inductor, and the second inductor may be adjusted based on different electromagnetic environments or operating frequency bands, and this is not limited in this application.

For the matching network in the foregoing embodiments, the first capacitor, the first inductor, and the second inductor are only possible schematic diagrams of the first radio frequency circuit 351, the second radio frequency circuit 352, and the third radio frequency circuit 354. In an actual production design, there may be other design forms. This is not limited in this application.

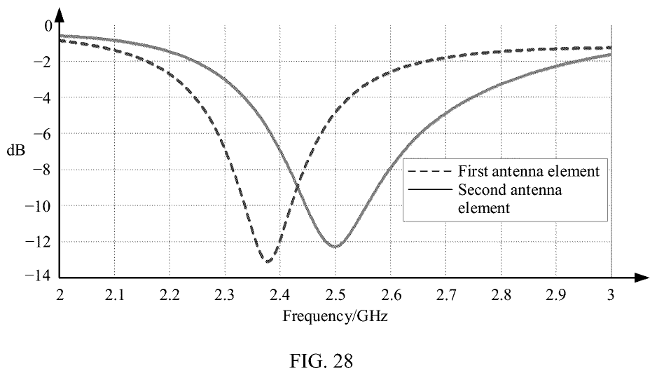

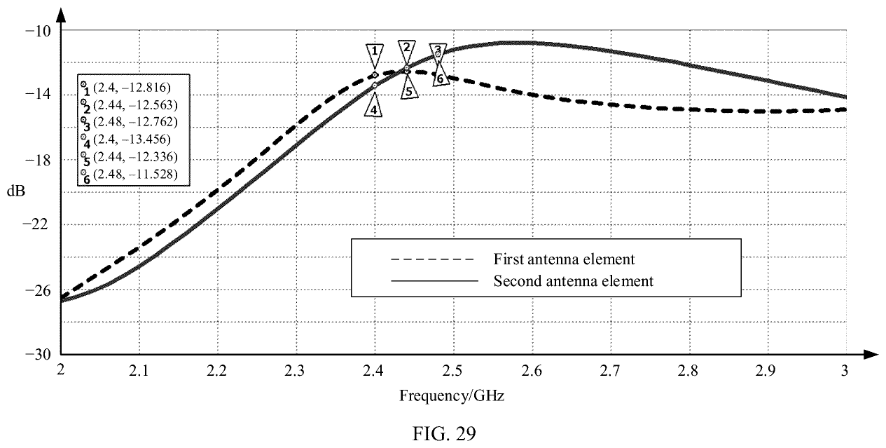

FIG. 28 and FIG. 29 are diagrams of simulation results, on a head model, of the antenna structure shown in FIG. 26. FIG. 28 is a diagram of S-parameter simulation results of the antenna structure shown in FIG. 26. FIG. 29 is a diagram of simulation results of system efficiency (total efficiency) of the antenna structure shown in FIG. 26.

As shown in FIG. 28, because the matching networks of the first antenna element and the second antenna element need to share the third radio frequency circuit, it is not possible to adjust a resonance point of the first antenna element and a resonance point of the second antenna element to be exactly the same, and the resonance point of one antenna element may be adjusted to lower frequency and the resonance point of the other antenna element may be adjusted to higher frequency: but a resonance bandwidth of the first antenna element and the second antenna element may support the Bluetooth frequency band (for example. 2.4 to 2.485 GHZ).

As shown in FIG. 29, in the Bluetooth frequency band (for example. 2.4 to 2.485 GHZ), system efficiency of the first antenna element and the second antenna element is greater than-13.5 dB, which can meet a communication requirement.

In embodiments of this application, a wearable device may support the Bluetooth frequency band through an antenna radiator. Whether a switch is in a first switch state or a second switch state, the wearable device may support the Bluetooth frequency band through the same antenna radiator.

It should be understood that this embodiment of this application only uses an example in which a resonant frequency band includes the Bluetooth frequency band for description. In an actual production design, the technical solution may also be applied to other communication frequency bands. This is not limited in this application.

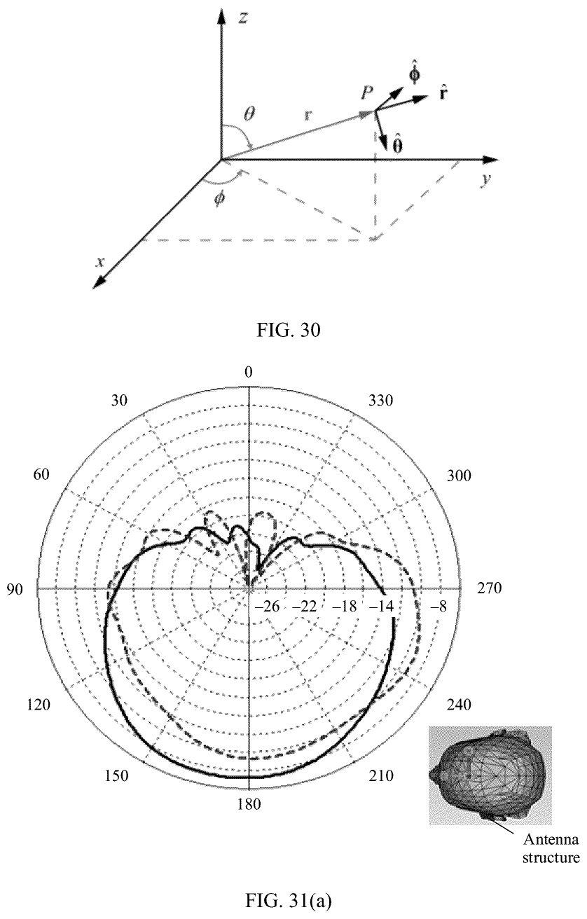

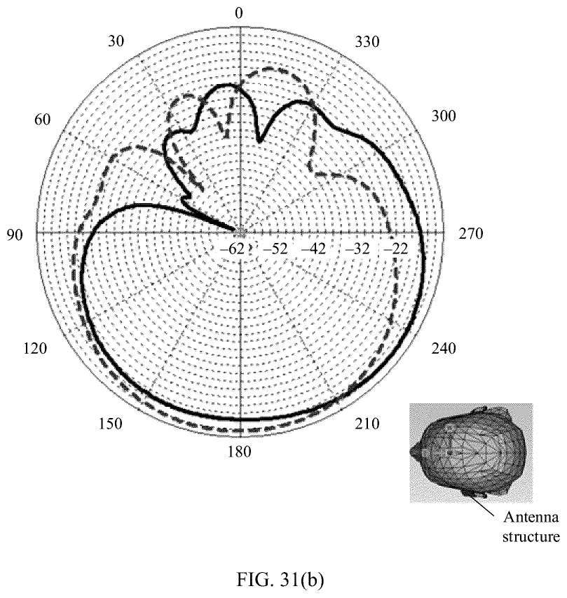

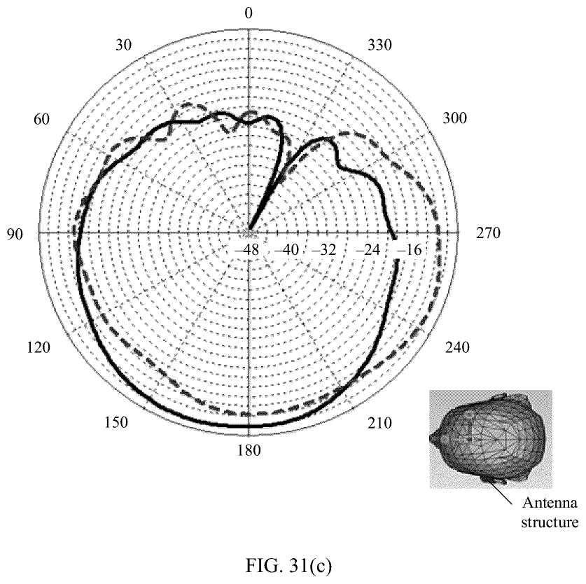

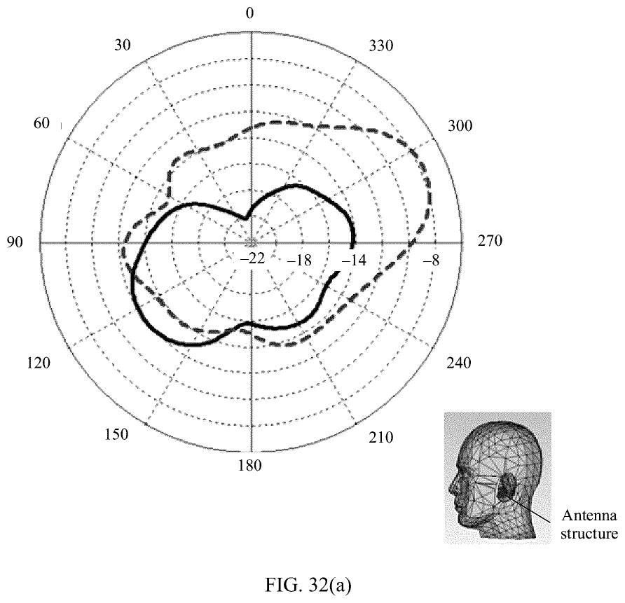

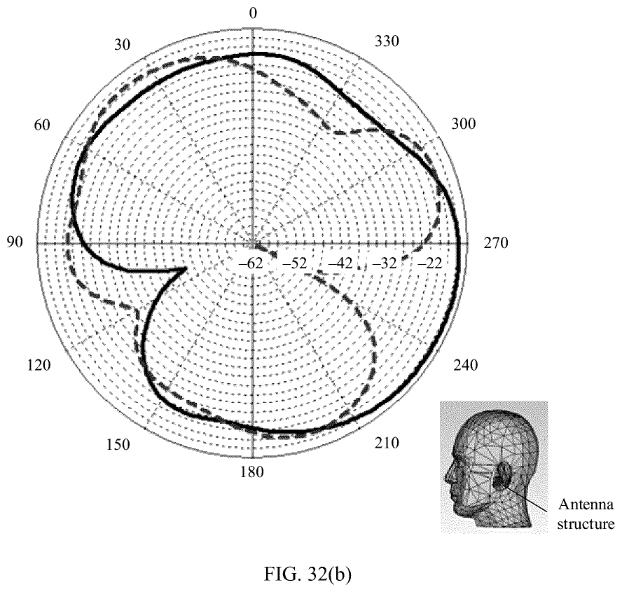

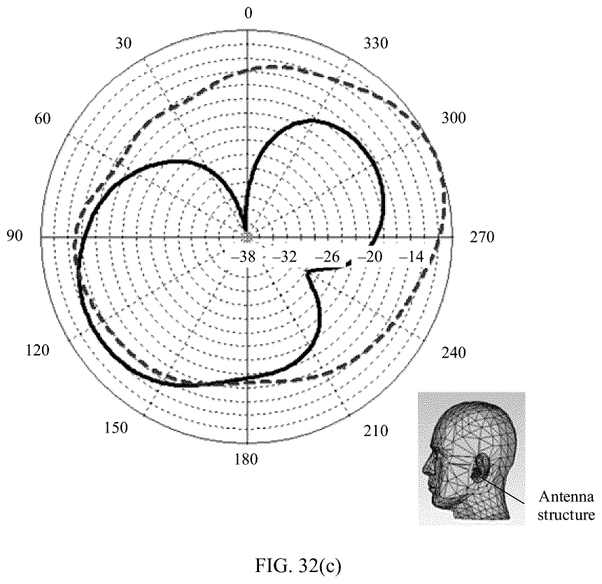

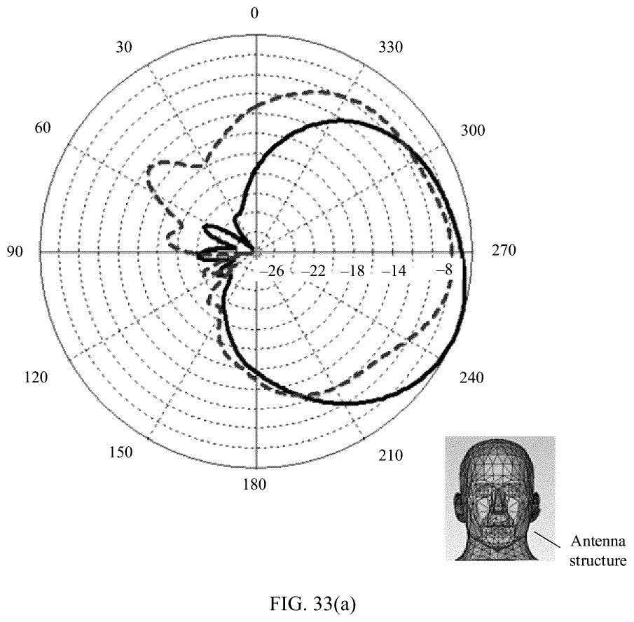

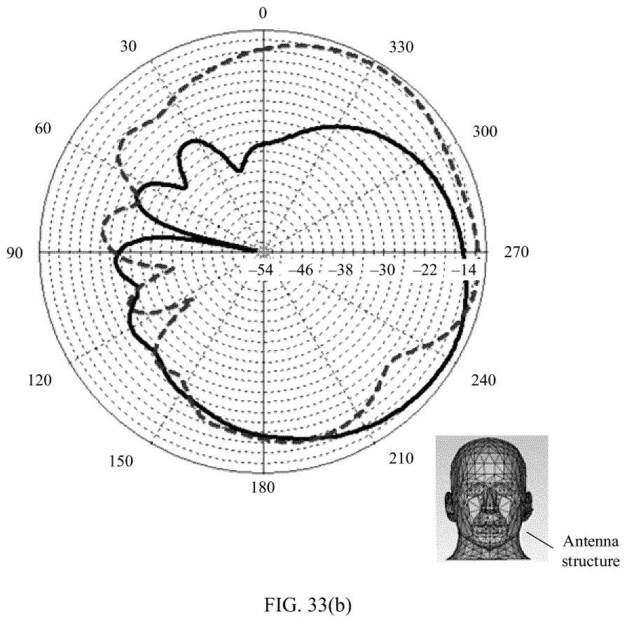

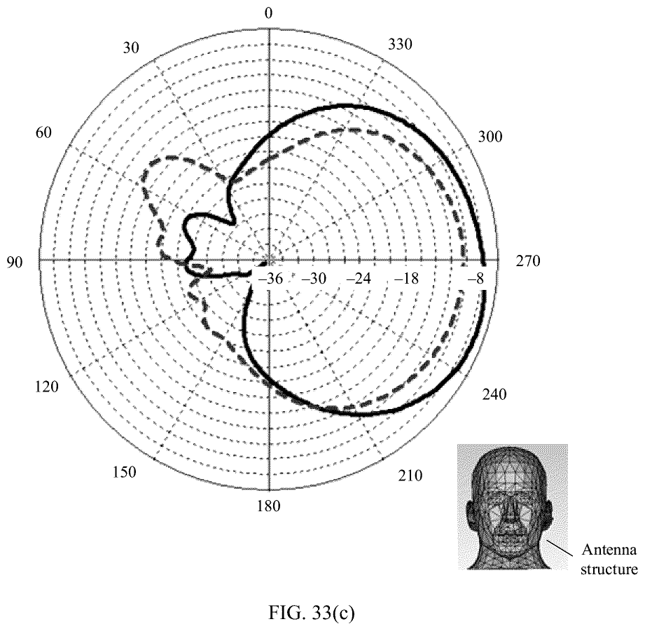

FIG. 30 to FIG. 33(a), FIG. 33(b), and FIG. 33(c) are patterns, on a head model, of the antenna structure shown in FIG. 26. FIG. 30 is a schematic diagram of coordinates in a polarization manner according to an embodiment of this application. FIG. 31(a), FIG. 31(b), and FIG. 31(c) are patterns, on a horizontal surface of a head model, of the antenna structure shown in FIG. 26. FIG. 32(a). FIG. 32(b), and FIG. 32(c) are patterns, on a lateral surface of a head model, of the antenna structure shown in FIG. 26. FIG. 33(a), FIG. 33(b), and FIG. 33(c) are patterns, on a front surface of a head model, of the antenna structure shown in FIG. 26.

As shown in FIG. 30, at any point P in three-dimensional space, a circle is obtained by using an origin O as a circle center, and a distance from the origin O to the P point as a radius. Theta polarization is polarization along a tangent direction of a line of longitude of the circle at the point P. Phi polarization is polarization along a tangent direction of a line of latitude of the circle at the point P, abs polarization is synthesis of the theta polarization and the phi polarization, abs is total polarization, and the theta polarization and the phi polarization are two polarization components of the abs polarization.

FIG. 31(a). FIG. 31(b), and FIG. 31(c) show patterns, on a horizontal surface of a head model, of the first antenna element and the second antenna element. FIG. 31(a). FIG. 31(b), and FIG. 31(c) respectively show patterns of abs polarization, theta polarization, and phi polarization. It can be seen that the first antenna element and the second antenna element have good radiation characteristics and complementary patterns, and may be used in an antenna structure for pattern switching.

FIG. 32(a). FIG. 32(b), and FIG. 32(c) show patterns, on a lateral surface of a head model, of the first antenna element and the second antenna element. FIG. 32(a), FIG. 32(b), and FIG. 32(c) respectively show patterns of abs polarization, theta polarization, and phi polarization. It can be seen that the first antenna element and the second antenna element have good radiation characteristics and complementary patterns, and may be used in an antenna structure for pattern switching.

FIG. 33(a). FIG. 33(b), and FIG. 33(c) show patterns, on a front surface of a head model, of the first antenna element and the second antenna element. FIG. 33(a). FIG. 33(b), and FIG. 33(c) respectively show patterns of abs polarization, theta polarization, and phi polarization. It can be seen that the first antenna element and the second antenna element have good radiation characteristics and complementary patterns, and may be used in an antenna structure for pattern switching.

This application provides a wearable device that may include an antenna structure, and the antenna structure may be designed based on a metal housing of the wearable device. Operating frequency of the antenna structure may support a communication connection between the wearable device and another electronic device. No matter when the electronic device connected to the wearable device is placed in a bag or pocket, or a user is in a place with strong signal interference such as an airport, a switch of the antenna structure switches between operating modes of the antenna structure, so that the stable communication connection between the wearable device and the electronic device can be implemented. Specifically, the wearable device with the antenna structure may switch the switch of the antenna structure, to increase coverage of a pattern of the antenna structure 201 (such as implement 360° omnidirectional coverage), so as to implement a stable connection of a signal. The communication connection can be a Bluetooth connection.

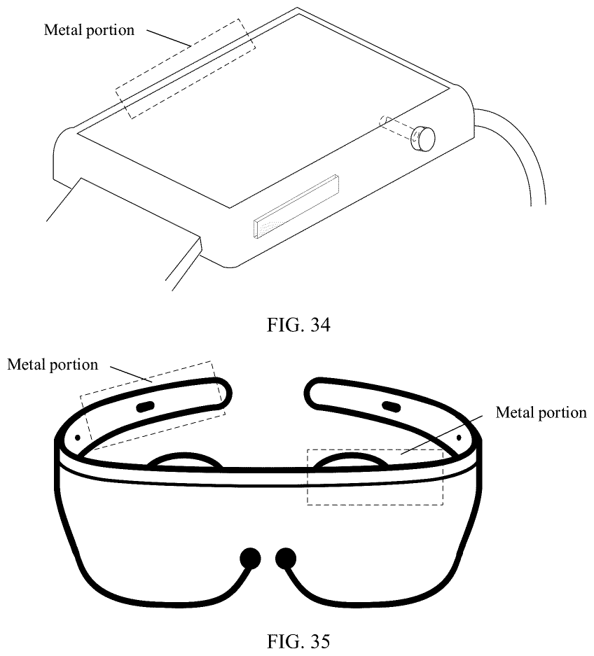

FIG. 34 and FIG. 35 show other wearable devices according to embodiments of this application.

It should be understood that the antenna structure provided in embodiments of this application may be used in wearable devices other than a TWS headset, for example, a smart watch or smart glasses.

As shown in FIG. 34, the antenna structure in the foregoing embodiment may be designed by using a metal housing of the smart watch, or may alternatively be adjusted based on an actual production design requirement. A specific location of the antenna structure is not limited in this application, and is only used as an example. For example, a watch bezel in the metal housing includes a metal portion, which may be configured as a radiator of the antenna structure. A PCB may be disposed in space enclosed by the metal housing. A feeding unit may be disposed on the PCB, electrically connected to one end of the metal portion that is in the watch bezel, and feeds the antenna structure. A switch may also be disposed on the PCB and electrically connected to the other end of the metal portion that is in the watch bezel. A design position of an antenna layout may be shown in FIG. 34. It should be understood that the antenna radiator may alternatively be disposed inside the housing of the smart watch.

As shown in FIG. 35, the antenna structure may be designed by using a temple of smart glasses, and a design position of an antenna layout is shown in the figure, or the antenna structure may alternatively be designed by using a frame of smart glasses, or may alternatively be adjusted based on an actual production design requirement. For example, the temple or frame of the smart glasses includes a metal portion (as shown in FIG. 35) that may be configured as a radiator of the antenna structure. A PCB may be disposed in the temple. A feeding unit may be disposed on the PCB, electrically connected to one end of the metal portion, and feeds the antenna structure. A switch may also be disposed on the PCB and electrically connected to the other end of the metal portion. A design position of the antenna layout is shown in FIG. 35.

A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing systems, apparatuses, and units, refer to a corresponding process in the foregoing method embodiments. Details are not described herein again.

In the several embodiments provided in this application, it should be understood that the disclosed systems, apparatuses, and methods may be implemented in other manners. For example, the foregoing apparatus embodiments are merely examples. For example, division of the units is merely logical function division and may be other division during actual implementation. For example, a plurality of units or components may be combined or integrated into another system, or some features may be ignored or not performed. In addition, the shown or discussed mutual couplings, direct couplings, or communication connections may be implemented through some interfaces. The indirect couplings or communication connections between the apparatuses or units may be implemented in electrical or another form.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A wearable device, comprising:
a housing, comprising a metal portion configured as an antenna radiator;
a printed circuit board (PCB) disposed in the housing opposite to the metal portion;
a feeding unit, electrically connected to a first end of the metal portion and feeds the antenna radiator; and
a first switch with one end electrically connected to a second end of the metal portion, and the other end grounded, wherein
the first switch is in a first switch state or a second switch state, an operating frequency band of the antenna radiator comprises a first frequency band.

2. The wearable device according to claim 1, wherein
a distance between a connection of the feeding unit and the metal portion and a connection of the end of the first switch and the metal portion is greater than or equal to one-eighth of a first wavelength corresponding to the first frequency band.

3. The wearable device according to claim 1, wherein
when the first switch is in the first switch state, the second end of the metal portion is grounded through the first switch; and
when the first switch is in the second switch state, the second end of the metal portion is not grounded through the first switch.

4. The wearable device according to claim 3, wherein the first switch is a single-pole single-throw switch, a single-pole double-throw switch, a single-pole four-throw switch, or a four-pole single-throw switch.

5. The wearable device according to claim 3, wherein the first switch is an adjustable capacitor, the first switch state corresponds to a first capacitance value of the adjustable capacitor, and the second switch state corresponds to a second capacitance value of the adjustable capacitor.

6. The wearable device according to claim 5, wherein the first capacitance value is less than or equal to 0.2 pF, and the second capacitance value is greater than or equal to 10 pF.

7. The wearable device according to claim 1, wherein
the PCB comprises a metal layer disposed opposite to the metal portion of the housing, and the other end of the first switch is electrically connected to the metal layer and grounded through the metal layer.

8. The wearable device according to claim 1, wherein at least one of the feeding unit or the first switch is disposed on the PCB.

9. The wearable device according to claim 1, wherein the wearable device comprises a matching network;
the first end of the metal portion comprises a first feeding point and a second feeding point;
the matching network comprises a first radio frequency circuit, a second radio frequency circuit, and a second switch;
one end of the first radio frequency circuit is electrically connected to the metal portion at the first feeding point, and the other end of the first radio frequency circuit is electrically connected to the second switch;
one end of the second radio frequency circuit is electrically connected to the metal portion at the second feeding point, and the other end of the second radio frequency circuit is electrically connected to the second switch; and
the second switch is electrically connected to the feeding unit.

10. The wearable device according to claim 9, wherein
the matching network further comprises a third radio frequency circuit; and
one end of the third radio frequency circuit is disposed between the second switch and the feeding unit, and the other end of the third radio frequency circuit is grounded.

11. The wearable device according to claim 10, wherein
the first radio frequency circuit comprises a first capacitor;
the second radio frequency circuit comprises a first inductor; and
the third radio frequency circuit comprises a second inductor.

12. The wearable device according to claim 11, wherein a capacitance value of the first capacitor is between 0.5 pF and 1.5 pF, an inductance value of the first inductor is between 1 nH and 2 nH, and an inductance value of the second inductor is between 1 nH and 2 nH.

13. The wearable device according to claim 11, wherein a capacitance value of the first capacitor is 1 pF, an inductance value of the first inductor is 1.5 nH, and an inductance value of the second inductor is 1.5 nH.

14. The wearable device according to claim 1, wherein the first frequency band is a Bluetooth frequency band.

15. The wearable device according to claim 1, wherein the wearable device is true wireless (TWS) headsets, a smart watch, or smart glasses.

16. An antenna, comprising: a radiator, a printed circuit board (PCB), a feeding unit, and a first switch, wherein
the radiator is disposed opposite to the PCB;
the feeding unit is electrically connected to a first end of the radiator and feeds the radiator; and
one end of the first switch is electrically connected to a second end of the radiator, and the other end of the first switch is grounded, wherein
the first switch is in a first switch state or a second switch state, and wherein an operating frequency band of the antenna comprises a first frequency band.

17. The antenna according to claim 16, wherein
a distance between a connection of the feeding unit and the radiator and a connection of the end of the first switch and the radiator is greater than or equal to one-eighth of a first wavelength corresponding to the first frequency band.

18. The antenna according to claim 16, wherein
when the first switch is in the first switch state, the second end of the radiator is grounded through the first switch; and
when the first switch is in the second switch state, the second end of the radiator is not grounded through the first switch.

19. The antenna according to claim 18, wherein the first switch is a single-pole single-throw switch, a single-pole double-throw switch, a single-pole four-throw switch, a four-pole single-throw switch, or an adjustable capacitor.

20. The antenna according to claim 16, wherein the first frequency band is a Bluetooth frequency band.
